(19) United States
(12) Patent Application Publication
(10) Pub. No.: US 2025/0184084 A1
(43) Pub. Date: Jun. 5, 2025

(54) TIMING ADVANCE AND CHANNEL STATE INFORMATION ENHANCEMENTS

(71) Applicant: Intel Corporation, Santa Clara, CA (US)

(72) Inventors: Bishwarup MONDAL, San Ramon, CA (US); Dong HAN, Santa Clara, CA (US); Avik SENGUPTA, Santa Clara, CA (US); Guotong WANG, Santa Clara, CA (US)

(21) Appl. No.: 18/832,061

(22) PCT Filed: Apr. 28, 2023
(86) PCT No.: PCT/US2023/066377

§ 371 Date: Jul. 22, 2024

Related U.S. Application Data
(60) Provisional application No. 63/336,991, filed on Apr. 29, 2022.
(60) Provisional application No. 63/485,804, filed on Feb. 17, 2023.

(51) Int. Cl. H04L 5/00; H04W 72/231; H04W 72/542

(52) U.S. Cl. CPC H04L 5/0053; H04L 5/0035; H04L 5/0048; H04W 72/231; H04W 72/542

(57) ABSTRACT

The present disclosure is generally related to wireless communications technologies, network topologies, and communication device implementations, and in particular, to multipletransmission reception point (multi-TRP) uplink (UL) transmission schemes. The multi-TRP UL transmission schemes include timing advance (TA) associations for multi-TRP operation, channel state information (CSI) enhancements, and codebook structural enhancements. To enhance the performance of Rel-16 codebook, a new codebook structure is constructed by preserving the Rel-16 codebook structure in the spatial dimension (SD) and frequency dimension (FD) while extending the Rel-16 codebook in the time dimension (TD) using a mutually orthogonal Discrete Fourier Transform (DFT) basis.

### CROSS REFERENCE TO RELATED APPLICATION

The present application claims priority to U.S. Provisional App. No. 63/336,991 filed Apr. 29, 2022 and U.S. Provisional App. No. 63/485,804 filed Feb. 17, 2023, the contents of each of which are hereby incorporated by reference in their entireties.

### FIELD

The present disclosure is generally related to wireless communications technologies, network topologies, and communication device implementations, and in particular, to multi-transmission reception point (TRP) uplink (UL) transmission schemes, channel state information (CSI) enhancements, and codebook structural enhancements.

### BACKGROUND

Fifth generation (5G) wireless networks support multiple transmit/receive point (multi-TRP) operation to provide improved reliability, coverage, and capacity performance. In multiple multi-TRP operation, a serving cell can schedule a user equipment (UE) from two transmit/receive points (TRPs), providing better coverage, reliability and/or data rates for physical downlink shared channel (PDSCH), physical downlink control channel (PDCCH), physical uplink shared channel (PUSCH), and physical uplink control channel (PUCCH).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts an example of simultaneous multi-transmission/reception point (TRP) uplink (UL) transmission;

FIG. 2 depicts an example UL-downlink (DL) timing relation and various example timing advance command messages;

FIG. 3 depicts an example user equipment precoder prediction scheme;

FIG. 4 depicts an example radio access network node precoder indication scheme;

FIG. 5 depicts an example measurement timing diagram including time gaps between adjacent measurements during a measurement time window;

FIG. 6 depicts an example three dimensional codebook structure;

FIGS. 7 and 8 depict example wireless networks; and

FIG. 9 depicts example hardware resources.

### DETAILED DESCRIPTION

The present disclosure discusses technologies and techniques for timing advance (TA) association for multi-TRP (mTRP) operation and channel state information (CSI) enhancements. To enhance the performance of Rel-16 codebook, a new codebook structure is constructed by preserving the Rel-16 codebook structure in the spatial dimension (SD) and frequency dimension (FD) while extending the Rel-16 codebook in the time dimension (TD) using a mutually orthogonal Discrete Fourier Transform (DFT) basis.

### 1. Multi-TRP, Timing Advance (TA), and Channel State Information (CSI) Aspects

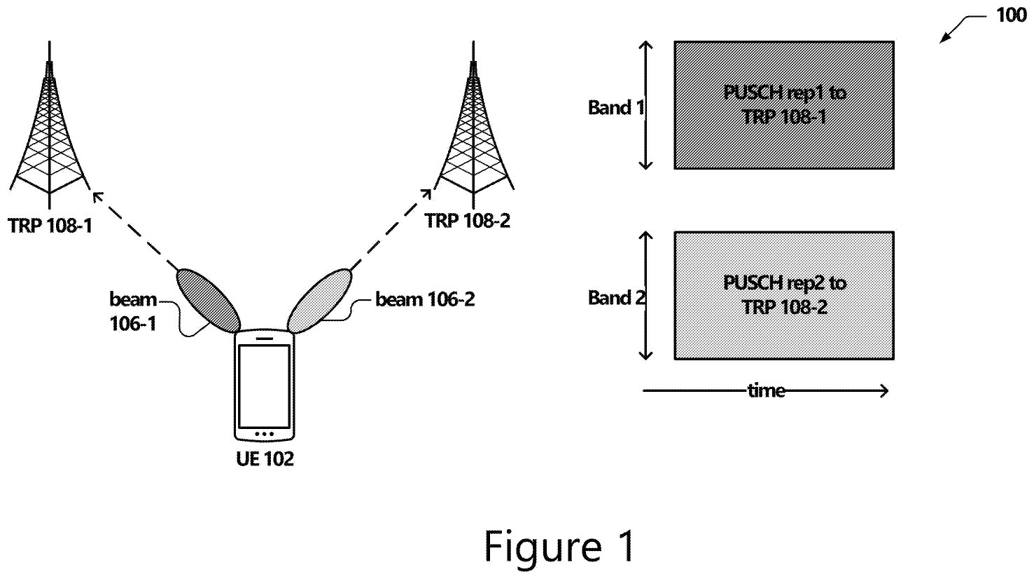

Release (Rel-)17 new radio (NR) supports mTRP physical uplink shared channel (PUSCH) and physical uplink control channel (PUCCH) repetitions/transmissions, which means the same uplink (UL) data or control information can be transmitted to multiple TRPs as multiple repetitions/transmissions in multiple time slots or sub-slots. However, in each time slot or sub-slot, there can be only one UL transmission occasion towards a certain TRP. To utilize the multiple TRPs more efficiently, Rel-18 5G/NR system supports simultaneous mTRP transmission schemes in UL. In particular, to increase the overall capacity, and to increase robustness of the transmission to potential blockage of the channel, a UE 102 could transmit signal(s) targeting two or more TRPs 108 simultaneously, as shown by FIG. 1.

FIG. 1 shows an example of mTRP operation 100. In mTRP operation, a serving cell can schedule the UE 102 from two or more TRPs (e.g., TRP 108-1 and TRP 108-2 in FIG. 1), providing better coverage, reliability and/or data rates for PDSCH, PDCCH, PUSCH, and PUCCH. In the example of FIG. 1, the UE 102 transmits a first beam 106-1 to (or towards) a first TRP 108-1 and a second beam 106-2 to (or towards) a second TRP 108-2. Additionally, the first beam 106-1 (in band 1) includes a first PUSCH repetition (rep1) to TRP 108-1 and the second beam 106-2 (in band 2) includes a second PUSCH repetition (rep2) to TRP 108-2. Here, the UE 102 may be the same or similar as UE 702, UE 802, hardware resources 900, and/or any other UE discussed herein; and the TRPs 108 may be the same or similar as the RAN 704, AP 706, ANs 708, AN 804, hardware resources 900, and/or any other AN/NAN discussed herein.

For mTRP PUSCH repetition/transmission, according to indications in a single downlink control information (DCI) or in a semi-static configured grant provided via radio resource control (RRC) signaling, the UE 102 performs PUSCH transmission of the same contents toward two or more TRPs 108 with corresponding beam directions 106 associated with different spatial relations. For mTRP PUCCH repetition, the UE 102 performs PUCCH transmission of the same contents toward two or more TRPs 108 with corresponding beam directions 106 associated with different spatial relations. For inter-cell multi-TRP operation, for mDCI PDSCH transmission, a transmission configuration indicator (TCI) state can be associated with a synchronization signal block (SSB) with a physical cell identifier (PCI) different from the serving cell PCI. The activated TCI states can be associated with at most one PCI different from the serving cell PCI at a time.

To support simultaneous mTRP transmission schemes in UL, different transmission schemes can be considered. For example, the mTRP transmissions can be scheduled by either a single DCI (sDCI) or multiple DCIs (mDCI), the mTRP transmission occasions can be multiplexed in the time domain (TD), frequency domain (FD), and spatial domain (SD); the resource allocation for mTRP transmission can be different; and/or the like.

In NR, a timing advance (“TA” or “T_{ADV}”) is a parameter or command sent by a base station (BS) (e.g., a TRP 108, RAN 704, AP 706, ANs 708, AN 804, hardware resources 900, and/or the like) to a UE 102 to adjust a UL (e.g., PUSCH, PUCCH, sounding reference signal (SRS), and/or the like) transmission timing. The UE 102 uses the TA to adjust it's UL frame timing relative to a DL frame timing.

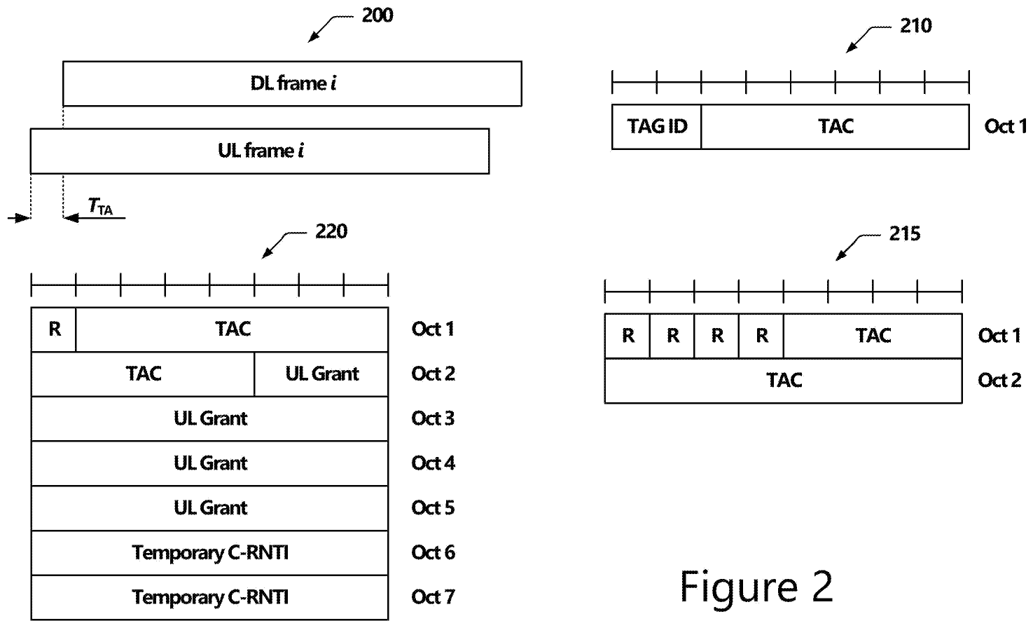

FIG. 2 shows an example UL-DL timing relation 200, where the parameter T_{TA} represents a TA between a DL frame i and a UL frame i. The UL frame i for transmission from the UE 102 starts at T_{TA} before the start of the corresponding DL frame i at the UE 102. The parameter T_{TA} can be computed according to the following equation:

$${T}_{TA} = ( {N}_{TA} + {N}_{TA , offset} + {N}_{TA , adj}^{common} + {N}_{TA , adj}^{UE} ) {T}_{c}$$

In the above equation, N_{TA} is the TA between DL and UL, except for msgA transmission on PUSCH where N_{TA}=0 is used (see e.g., [TS38213]§ 4.2); N_{TA,offset} is a fixed offset used to calculate the TA (see e.g., [TS38213]§ 4.2); N_{TA,adj} is a network-controlled timing correction (see e.g., [TS38213]§ 4.2) derived from the higher-layer parameters TACommon, TACommonDrift, and TACommonDriftVariation if configured, otherwise N_{TA,adj}^{common}=0; N_{TA,adj}^{UE} is a UE-derived timing correction (see e.g., [TS38213]§ 4.2), which is computed by the UE 102 based on UE position and serving-satellite-ephemeris-related higher-layers parameters if configured, otherwise N_{TA,adj}^{UE}=0; and T_{c} is a basic time unit for NR (see e.g., [TS38211]§ 4.1).

The BS determines a desired TA setting and provides the TA to the UE 102. The UE 102 uses the provided TA to determine its UL transmit timing relative to the UE's 102 observed DL receive timing (e.g., T_{TA}). For example, the BS measures a time difference between the reception of a UL transmission (e.g., PUSCH, PUCCH, SRS, and/or the like) and a local subframe timing so that it knows whether the UL transmission arrives at the BS too early or too late. Then, the BS calculates or otherwise determines a TA, generates a TA command (TAC), and sends the TA/TAC to the UE 102. The UE 102 adjusts its upcoming/scheduled UL transmission according to the TAC value to align the UL transmission with the BS's subframe timing. For example, the UE 102 transmits earlier if the TAC value is positive, and the UE 102 transmits later if the TAC value is negative.

A BS is responsible for maintaining a TA to keep the layer 1 (L1) synchronized. Serving cells having UL to which the same TA applies and using the same timing reference cell are grouped in a TA group (TAG). A TAG is a group of serving cells that is configured by RRC and that, for the cells with a UL configured, use the same timing reference cell and the same TA value. According to various embodiments, a serving cell or TAG can use at least two different TA values, as discussed infra.

Each TAG contains at least one serving cell with configured UL, and the mapping of each serving cell to a TAG is configured by RRC. For example, an RRC message can include a serving cell configuration (e.g., ServingCellConfig information element (IE)), which is used to configure (e.g., add or modify) the UE 102 with a serving cell. The configured serving cell may be a special cell (SpCell) or an secondary cell (SCell) of a master cell group (MCG) or secondary cell group (SCG). The ServingCellConfig IE includes a “tag-Id” field that includes a TAG ID, as discussed herein and/or as specified in [TS38321], that the serving cell belongs to. The RRC entity/layer also configures the following parameters for the maintenance of UL time alignment: timeAlignmentTimer (per TAG), which controls how long the MAC entity considers the serving cells belonging to the associated TAG to be UL time aligned; inactivePosSRS-TimeAlignmentTimer, which controls how long the MAC entity considers the positioning SRS transmission in RRC_INACTIVE (see e.g., clause 5.26 of [TS38321]) to be UL time aligned; and/or eg-SDT-TimeAlignmentTimer, which controls how long the MAC entity considers the UL transmission for configured grant-based small data transmission (CG-SDT) to be UL time aligned. For a primary TAG (PTAG), the UE 102 uses the primary cell (PCell) as a timing reference, except with shared spectrum channel access where an SCell can also be used in certain cases (see e.g., [TS38133]§ 7.1). In a secondary TAG (STAG), the UE 102 may use any of the activated SCells of this TAG as a timing reference cell, but should not change it unless necessary.

Additionally or alternatively, the UE 102 can be provided with the value N_{TA,offset} of a TA offset for a serving cell by a parameter n-TimingAdvanceOffset for the serving cell. If the UE 102 is not provided with the n-TimingAdvanceOffset parameter for a serving cell, the UE 102 determines a default value N_{TA,offset} of the TA offset for the serving cell as described in [TS38133]. If the UE 102 is configured with two UL carriers for a serving cell, a same TA offset value N_{TA,offset} applies to both carriers. Upon reception of a TAC for a TAG, the UE 102 adjusts UL timing for a UL transmission (e.g., PUSCH, SRS, PUCCH, and/or the like) on all the serving cells in the TAG based on the value N_{TA,offset} that the UE 102 expects to be same for all the serving cells in the TAG and based on the received TAC where the UL timing for UL transmissions is the same for all the serving cells in the TAG. For a subcarrier spacing (SCS) of 2^{μ}·15 kHz, the TAC for a TAG indicates the change of the UL timing relative to the current UL timing for the TAG in multiples of 16·64·T_{c}/2^{μ}. The start timing of the random access (RA) preamble is described in [TS38211].

TA updates are signalled by the BS to the UE 102 via a TAC medium access control (MAC) control element (CE), an absolute TAC (aTAC) MAC CE, or a random access response (RAR). FIG. 2 also shows an example TAC MAC CE 210, which is identified by MAC subheader with a logical channel ID (LCID) as specified in Table 6.2.1-1 of [TS38321] (e.g., the LCID for a TAC MAC CE 210 has a codepoint/index value of “61”). The TAC MAC CE 210 has a fixed size and includes a single octet. The TAC MAC CE 210 includes a 2 bit TAG Identity (TAG ID) field, which indicates the TAG identity/identifier (TAG-Id) of the addressed TAG. In some examples, a TAG containing the SpCell has the TAG-Id of 0. The TAC MAC CE 210 also includes a 6 bit TAC field, which includes or indicates an index value TA (e.g., 0, 1, 2 . . . 63), which is used to control the amount of timing adjustment that the MAC entity has to apply (see e.g., [TS38213]). For the TAC MAC CE 210, a TAC (“T_{A}”) for a TAG indicates an adjustment of a current N_{TA} value (“N_{TA_old}”) to a new N_{TA} value (“N_{TA_new}”) by index values of T_{A}=0, 1, 2, . . . , 63, wherein for an SCS of 2^{μ}·15 kHz, N_{TA_new}=N_{TA_old}+(T_{A}−31)·16·64/2^{μ}.

FIG. 2 also shows an example aTAC MAC CE 215 and an example RAR MAC CE 220. The aTAC MAC CE 215 is identified by MAC subheader with an extended LCID (eLCID) as specified in Table 6.2.1-1b of [TS38321] (e.g., a codepoint value of “252” and an index value of “316”). The aTAC MAC CE 215 has a fixed size and includes two octets. The aTAC MAC CE 215 includes a set of reserved fields (R), which are 1 bit each and are set to 0. The aTAC MAC CE 215 also includes a 12 bit TAC field, which includes or indicates the index value T_{A}, which is used to control the amount of timing adjustment that the MAC entity has to apply (see e.g., [TS38213]). In some implementations, the aTAC MAC CE 215 can include a 2 bit TAG ID field in place of two of the reserved bits, or the 2 bit TAG ID field can be part of the 12 bit TAC field.

The RAR MAC CE 220 (also referred to as a “MAC RAR 220”) is identified by MAC subheader with a 6 bit RA preamble identifier (RAPID) field (e.g., the RAPID field includes or identifies the transmitted RA preamble and/or preamble index (see e.g., [TS38321]§ 5.1.3)). The MAC RAR 220 has a fixed size and includes seven octets. The MAC RAR 220 includes a 1 bit reserved field (R) that is set to 0. The MAC RAR 220 also includes a 12 bit TAC field that includes or indicates the index value T_{A}, which is used to control the amount of timing adjustment that the MAC entity has to apply (see e.g., [TS38213]); a 27 bit UL grant field that includes or indicates the resources to be used on the uplink in [TS38213]; and a 16 bit temporary C-RNTI field that includes or indicates a temporary identity that is used by the MAC entity during the RA procedure. In some examples, the MAC RAR 220 is transmitted in an Msg2 during a Type-1 L1 RA procedure, or the MAC RAR 220 is transmitted in an MsgA or MsgB during a Type-2 L1 RA procedure (see e.g., [TS38213] and [TS38300]). In some implementations, the MAC RAR 220 can include a 2 bit TAG ID field in place of two of the reserved bits, or the 2 bit TAG ID field can be part of the 12 bit TAC field. A MAC payload for a MsgB message (also referred to as a fallbackRAR) can include the same or similar payload as the MAC RAR 220. Additionally or alternatively, the same or similar TAC field can also be includes in a successRAR MAC PDU. For the RAR MAC CE 220 or the aTAC MAC CE 215, the TAC (“T_{A}”) for a TAG indicates N_{TA} values by index values of T_{A}=0, 1, 2, . . . , 3846, where an amount of the time alignment for the TAG with SCS of 2^{μ}·15 KHz is N_{TA}=T_{A}·16·64/2^{μ}. N_{TA} is defined in [TS38211] and is relative to the SCS of the first UL transmission from the UE after the reception of the RAR MAC CE 220 or the aTAC MAC CE 215.

Furthermore, a TAC starts or restarts one or more TAG-specific timers, which indicates whether the L1 can be synchronized or not. When the timer(s) is/are running, the L1 is considered synchronized; otherwise, the L1 is considered non-synchronised in which case UL transmission can only take place through MSG1 (e.g., the preamble transmission of the RA procedure for 4-step RA type) and/or MSGA (e.g., the preamble and payload transmissions of the RA procedure for 2-step RA type). In one example, when a TAC MAC CE is received by the UE 102 and if an N_{TA} has been maintained with the indicated TAG, the UE's 102 MAC entity applies the TAC for the indicated TAG; starts or restarts the inactivePosSRS-TimeAlignmentTimer associated with the indicated TAG if there is ongoing positioning SRS transmission in RRC_INACTIVE, starts or restarts the eg-SDT-TimeAlignmentTimer associated with the indicated TAG if CG-SDT procedure triggered; otherwise, the MAC entity starts or restarts the timeAlignmentTimer associated with the indicated TAG (see e.g., [TS38321]§ 5.2). In another example, when a TAC is received in a RAR message for a serving cell belonging to a TAG or in a MsgB for an SpCell, and if the RA preamble was not selected by the MAC entity among the contention-based RA preamble, the UE's 102 MAC entity applies the TAC for this TAG and starts or restarts the timeAlignmentTimer associated with this TAG; else if the timeAlignmentTimer associated with this TAG is not running, the UE's 102 MAC entity applies the TAC for this TAG and starts the timeAlignmentTimer associated with this TAG, and stops timeAlignmentTimer associated with this TAG when the contention resolution is considered not successful as described in [TS38321]§ 5.1.5 of or when the contention resolution is considered successful for SI request as described in [TS38321]§ 5.1.5 after transmitting HARQ feedback for MAC PDU including UE contention resolution identity MAC CE. When the contention resolution is considered not successful as described in [TS38321]§ 5.1.5 and if CG-SDT procedure triggered as in [TS38321]§ 5.27 is ongoing, the UE's 102 MAC entity sets the N_{TA} value to the value before applying the received TAC. When the contention resolution is considered successful for RA procedure while the CG-SDT procedure is ongoing, the UE's 102 MAC entity stops timeAlignmentTimer associated with this TAG, and starts or restarts the eg-SDT-TimeAlignmentTimer associated with this TAG. When the contention resolution is considered successful for RA procedure while SRS transmission in RRC_INACTIVE is ongoing, the UE's 102 MAC entity starts or restarts the inactivePosSRS-TimeAlignmentTimer associated with this TAG. Otherwise, the UE's 102 MAC entity ignores the received TAC.

3GPP Rel-16 includes a TA for single-TRP. For example, a serving cell is associated with one UL timing and multiple serving cells within the same TAG is/are associated with the same UL timing. However, the TA for single-TRP does not work well for mTRP based transmission because the transmission to different TRPs may have different TAs. In Rel-18, mTRP operation including simultaneous multi-panel transmission is supported, which requires associating a serving cell with 2 UL timings (2 TA fields). In addition, a serving cell may transition from single TRP operation to mDCI mTRP operation, and vice versa, of which the TA related issues should be specified.

### 1.1. TA Enhancements

As mentioned previously, to support mTRP operation including simultaneous multi-panel transmission, two TAs can be computed. In order to apply the TA values properly to UL transmission, a UE 102 needs to associate a UL transmission to a TA value field (e.g., a TAC field in a MAC CE 210, 215 or 220). Note that DL and UL transmissions do not need to be associated with the same TRP 108 (or TCI state) so re-using the parameter CORESETPoolIndex may not be sufficient. In that sense, there is no need to limit such operation to mDCI mTRP only.

In the case of intra-cell mDCI mTRP operation, each of the TRPs 108 may benefit from estimating a TA from a PRACH transmission, and a TRP identifier (TRP-Id) is associated with a TA value included in a RAR and/or MAC CE. Thus, in some embodiments, a serving cell is associated with at least two (2) TA fields and the activation/de-activation of TA fields is per serving cell. Additionally or alternatively, unified TCI states and UL-TCI states are associated with a TRP-Id, and a TRP-Id is associated with a TA.

The TRP-Id is an identifier or identity of a TRP 108 within a RAN node or cell, and may be expressed as an integer, string, and/or the like. Additionally or alternatively, a TRP-Id may can be based on one or more of a cell identity (e.g., NR cell identity), PCI, NCGI, NG-RAN CGI, ARFCN, DL-PRS-ID, PLMN Identity, cell portion ID, NRPPa transaction ID, and/or any other identifier(s) and/or network address(es), such as any of those discussed herein. In some embodiments, the TRP-Id may be provided in a suitable configuration and/or information element (IE) such as, for example, AreaID-CellList IE, DL-PRS-ID-Info IE, ARFON-ValueNR IE, NCGI IE, NR-PhysCellId IE, TRP Information IE, TRP ID IE (see e.g., [TS38455]§ 9.2.24), NRPPa Transaction ID) IE, and/or any other suitable configurations/IEs, such as any of those discussed herein (see e.g., 3GPP TS 37.355 v17.4.0 (2023 Mar. 31) (“[TS37355]”), 3GPP TS 38.305 v17.4.0 (2023 Mar. 28), and 3GPP TS 38.455 v17.4.0 (2023 Apr. 3) (“[TS38455]”)). These configurations/IEs may be included in a suitable RRC message, non-access stratum (NAS) message, system information (SI) broadcast, LTE positioning protocol (LPP) message, NR Positioning Protocol (NRPP) message, and/or the like.

In various embodiments, a TAG-Id is indicated or provided to a UE 102 using configuration(s) and/or IE(s) according to any combination of the following examples.

In a first example, a TAG and/or TA is associated with an SRS resource (SRS-Resource) and/or SRS resource ID (SRS-ResourceId). In this example, the network (NW) (e.g., BS, RAN node, or other network element) indicates a TAG-Id to the UE 102 using one or more SRS resource indicator (SRI) fields in a DCI (e.g., DCI format 0_1, 0_2, and/or the like). In the absence of an SRI field, a default TAG is assumed by the UE 102.

In a second example, a TAG and/or TA is associated with an SRS resource set (SRS-ResourceSet) and/or SRS resource set ID (srs-ResourceSetId). In this example, the NW (e.g., BS, RAN node, or other network element) indicates a TAG-Id to the UE 102 using an SRS resource set indicator field in a DCI (e.g., DCI format 0_1, 0_2, and/or the like). In the absence of an SRS resource set indicator field, a default TAG may be assumed by the UE 102. Additionally or alternatively, a TAG/TA is associated with an SRS resource set/SRS resource set ID associated with a type of “codebook” or “non-codebook”.

In a third example, a TAG and/or TA is associated with SRS-SpatialRelationInfo field/IE in an SRS configuration (SRS-Config), while SRS-SpatialRelationInfo is applied in FR1 where the UE 102 ignores the referenceSignal” IE shown by Table 1.1-1. The SRS configuration (SRS-Config) IE is used to configure sounding reference signal (SRS) transmissions. The configuration defines a list of SRS-Resources, a list of SRS-PosResources, a list of SRS-PosResourceSets and a list of SRS-ResourceSets. Each resource set defines a set of SRS-Resources or SRS-PosResources. The network triggers the transmission of the set of SRS-Resources or SRS-PosResources using a configured aperiodicSRS-ResourceTrigger (L1 DCI). In this example, the parameter “tag-Id” is the TAG ID associated with this SRS-SpatialRelationInfo.

TABLE 1.1-1
SRS-SpatialRelationInfo information element

| | |
|---|---|
| SRS-SpatialRelationInfo : := | SEQUENCE { |
| servingCellId | ServCellIndex OPTIONAL, -- Need S |
| tag-Id | TAG-Id |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |
| } | |
| } | |
| } | |

In a fourth example, a TAG and/or TA is associated with PUSCH power control information, such as an SRI-PUSCH-PowerControl IE (see e.g., Table 1.1-2) in a PUSCH power control configuration (PUSCH-PowerControl). The PUSCH-PowerControl configuration/IE is used to configure UE specific power control parameter for PUSCH. In the absence of an indication of SRI-PUSCH-PowerControl information to the UE 102, a default TAG is assumed. In this example, the parameter “tag-Id” is the TAG ID associated with this SRI-PUSCH-PowerControl.

TABLE 1.1-2
SRI-PUSCH-PowerControl information element

SRI-PUSCH-PowerControl SEQUENCE {

| | |
|---|---|
| tag-Id | TAG-Id |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |
| } | |

In a fifth example, a TAG and/or TA is associated with a PUCCH resource. This association may be indicated to the UE 102 using RRC configuration or using some other suitable mechanism. A PUCCH resource is indicated to the UE 102 using a field in DCI (e.g., PUCCH resource indicator field).

In a sixth example, in FR1, a TAG and/or TA is associated with PUCCH power control information, such as a PowerControlSetInfo IE (see e.g., Table 1.1-3) in a PUCCH power control configuration (PUCCH-PowerControl). The PUCCH-PowerControl configuration/IE is used to configure UE-specific parameters for the power control of PUCCH. In this example, the parameter “tag-Id” is the TAG ID associated with this SRI-PUSCH-PowerControl.

TABLE 1.1-3
PowerControlSetInfo information element

| | |
|---|---|
| PUCCH-PowerControlSetInfo-r17 : := | SEQUENCE { |
| pucch-PowerControlSetInfoId-r17 | PUCCH-PowerControlSetInfoId-r17, |
| tag-Id | TAG-Id |
| p0-PUCCH-Id-r17 | P0-PUCCH-Id, |
| pucch-ClosedLoopIndex-r17 | ENUMERATED { i0, i1 }, |
| pucch-PathlossReferenceRS-Id-r17 | PUCCH-PathlossReferenceRS-Id-r17 |
| } | |

In a seventh example, in FR1, a TAG and/or TA is associated with PUCCH spatial relation information, such as a PUCCH-SpatialRelationInfo IE as shown by Table 1.1-4. The PUCCH-SpatialRelationInfo IE is used to configure the spatial setting for PUCCH transmission and the parameters for PUCCH power control (see e.g., [TS38213]§ 9.2.2). In this example, the parameter “tag-Id” is the TAG ID associated with this PUCCH-SpatialRelationInfo.

TABLE 1.1-4
PUCCH-SpatialRelationInfo information element

| | |
|---|---|
| PUCCH-SpatialRelationInfo : := | SEQUENCE { |
| pucch-SpatialRelationInfoId | PUCCH-SpatialRelationInfoId, |
| servingCellId | ServCellIndex OPTIONAL, -- Need S |
| tag-Id | TAG-Id |
| referenceSignal | CHOICE |
| ssb-Index | SSB-Index, |
| csi-RS-Index | NZP-CSI-RS-ResourceId, |
| srs | PUCCH-SRS |
| }, | |
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |
| } | |

### 1.2. CSI Enhancements

CSI enhancement is also within the scope of Rel-18. For example, Rel-18 targets to enhance the CSI processing under the scenario where the UE has high or medium mobility, and design new codebooks for transmission.

Mathematically a Rel-16 codebook can be expressed as:

$$W ( p , r , k ) = {A}_{p , r} \cdot {\sum }_{i = 0}^{L - 1} \{ {v}_{{l}^{( i )} , {k}^{( i )}} {\sum }_{m = 0}^{M - 1} {b}^{( i , m , p , r )} \cdot {a}_{i , m , p , r} \cdot {φ}_{i , m , p , r} \cdot {e}^{j \frac{2 π k \cdot {g}^{( m , r )}}{{N}_{3}}} \}$$

In the above equation, W (p, r, k) is a precoder vector and p, r, k represents the polarization, layer and FD compression unit indices; L and M are mutually orthogonal number of SD and FD DFT vectors selected with indices reported by the UE 102; N₃ is the total number of FD-compression units; vₗ_{⁽ⁱ⁾}_{,k}_{⁽ⁱ⁾}=dₗ_{⁽ⁱ⁾}⊗uₖ_{⁽ⁱ⁾}, l⁽ⁱ⁾ and k⁽ⁱ⁾ are the indices of the SD DFT vectors; g^{(m,r)} are the indices of the FD DFT vectors; b^{(i,m,p,r)} is the coefficient down-selection bit represented by the UE 102; A_{p,r} is the reference polarization amplitude reported by the UE 102; and α_{i,m,p,r}, φ_{i,m,p,r} are the amplitude and phase coefficient reported by the UE 102. However, Rel-16 codebook and/or Rel-16 precoder is/are not designed or otherwise based on time domain.

The CSI-RS is transmitted from the BS to the UE 102 for channel estimation. Rel-18 targets to enhance the CSI processing under the scenario where the UE 102 has high or medium mobility.

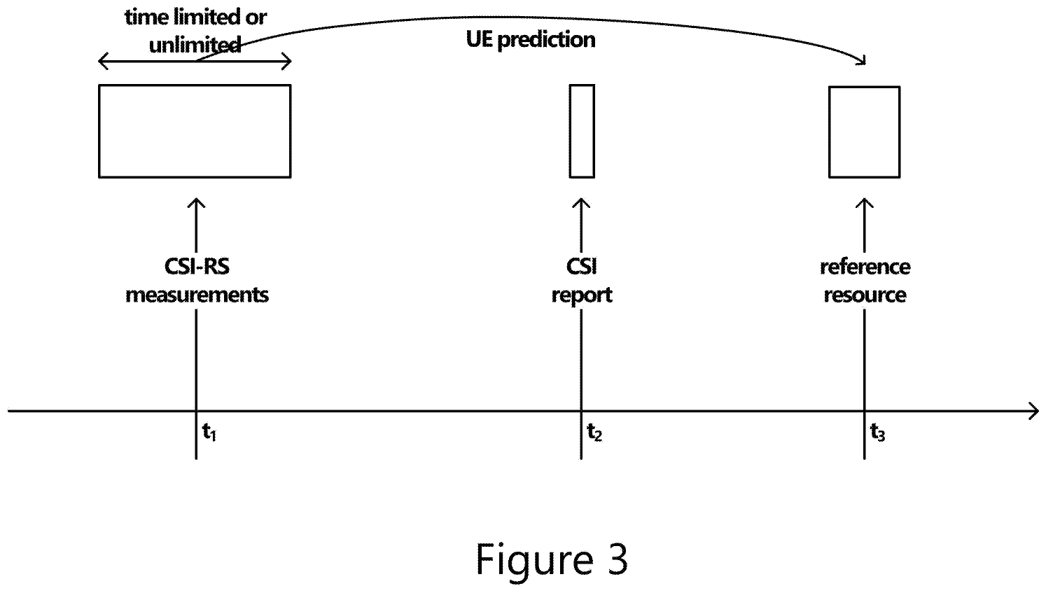

In some embodiments, CSI prediction can be applied at the UE 102 side. As shown by FIG. 3, the UE 102 measures CSI-RS instances within a time window at time t₁, determine predicted doppler-domain compressed CSI associated with a reference resource at time t₃ and report it at time t₂. The specific prediction algorithm (or predictive service) used may be based on UE implementation. As examples, the prediction algorithm (or predictive service) can include one or more machine learning (ML) models/algorithms such as, for example, an artificial neural network including any of those discussed herein. The UE 102 has access to unquantized and instantaneous channel information that may be better suitable for prediction. At the same time, UE complexity should be considered and also perhaps new RAN4 work is needed to establish predicted CSI tests to guarantee performance requirements.

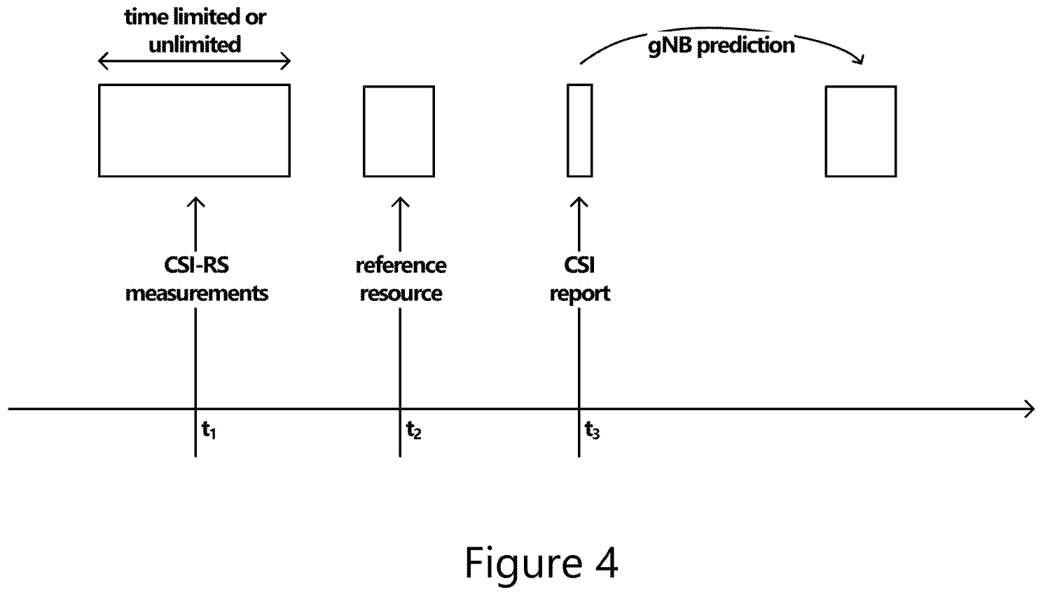

Additionally or alternatively, CSI prediction can be applied at the RAN node (e.g., gNB 716, TRP 108, and/or the like) side. As shown by FIG. 4, a UE 102 measuring on a time window of CSI-RS instances at time t₁, determining doppler-domain compressed CSI associated with a reference resource at time t₂ and reporting it at time t₃. It is up to RAN node (e.g., gNB 716, TRP 108, and/or the like) implementation to perform prediction of CSI based on the received compressed information from the UE 102.

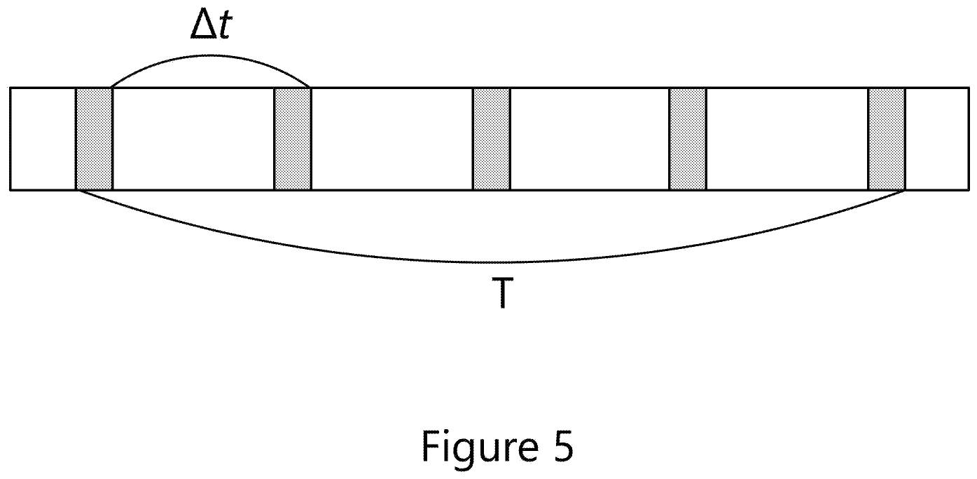

Additionally or alternatively, the sampling period and measurement time window for CSI processing should be optimized. As shown by FIG. 5, the UE 102 measures the CSI-RS is transmitted in the colored blocks. In FIG. 5, Δt is a time gap between adjacent measurements (sampling period) and T is the measurement time window. Denoting fₘₐₓ to be the maximum Doppler frequency intended to be handled, if the CSI-RS periodicity is 1/(2·fₘₐₓ)≤Δt≤1/(fₘₐₓ), aliasing effect of spurious Doppler components will happen. And if the CSI-RS periodicity is 1/(fₘₐₓ)≤Δt, the effect of mobility is not fully captured. Thus, in order to satisfy the Nyquist criterion, the sampling period and maximum Doppler frequency should satisfy this relationship, Δt≤1/(2·fₘₐₓ). Moreover, the frequency (Doppler) resolution increases with T, and prediction error will depend on the measurement time T.

### 1.3. Enhanced Codebook Structure

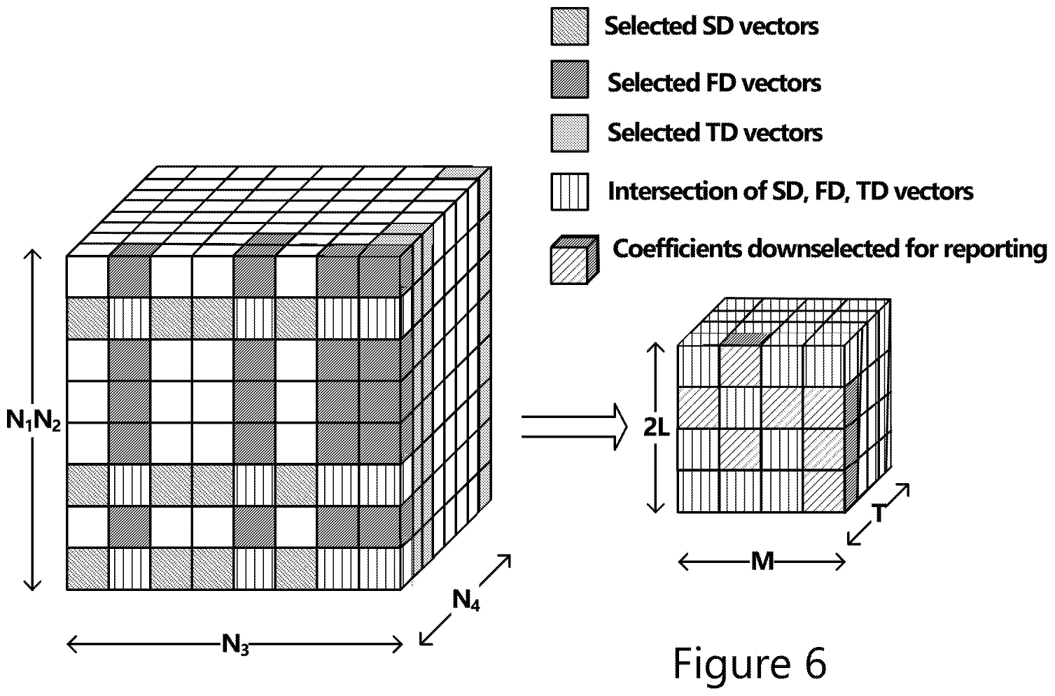

In some embodiments, a new codebook structure can be constructed by preserving the Rel-16 codebook structure in the spatial and frequency dimensions (SD and FD) while extending it in time dimension (TD) using a mutually orthogonal DFT basis. FIG. 6 shows an example codebook structure where N₁, N₂, N₃, and N₄ are the number of azimuth, elevation, frequency and time units (dimensions).

Following the same notation as Rel-16 codebook and extending it to time-domain compression, an example of a codebook structure can be given by:

$$W ( p , r , k , t ) = {A}_{p , r} \cdot {\sum }_{i = 0}^{L - 1} \{ {v}_{{l}^{( i )} , {k}^{( i )}} {\sum }_{m = 0}^{M - 1} \{ {e}^{j \frac{2 π k \cdot {g}^{( m , r )}}{{N}_{3}}} {\sum }_{s = 0}^{T - 1} {b}^{( i , m , s , p , r )} \cdot {a}_{i , m , s , p , r} \cdot {φ}_{i , m , s , p , r} \cdot {e}^{j \frac{2 π t \cdot {f}^{( s , r , … )}}{{N}_{4}}} \} \}$$

In the above equation, W(p, r, k, t) is a precoder vector where t represents the TD compression unit index; N₄ is the total number of time-compression units; T is the number of TD DFT vectors selected with indices reported by the UE 102; f^{(s,r, . . . )} are the indices of the TD DFT vectors; b^{(i,m,s,p,r)} is the coefficient down-selection bit represented by the UE 102; and α_{i,m,s,p,r}, φ_{i,m,s,p,r} are the amplitude and phase coefficients reported by the UE 102.

### 1.4. Physical Uplink Shared Channel Aspects

In addition to the information discussed in [TS38213], [TS38214], and/or as modified according to the examples discussed herein, PUSCH transmission(s) can be dynamically scheduled by an uplink (UL) grant in a downlink control information (DCI) (e.g., DCI format 0_0, 0_1, 0_2, and/or the like), or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to clause 10.2 of [TS38213] after the reception of higher layer parameter configuredGrantConfig not including rrc-ConfiguredUplinkGrant. If configuredGrantConfigToAddModList is configured, more than one configured grant configuration of configured grant Type 1 and/or configured grant Type 2 may be active at the same time on an active BWP of a serving cell.

For a PUSCH transmission on active UL BWP b, as described in clause 12 of [TS38213], of carrier f of serving cell c, a UE 102 first calculates a linear value \hat{P}_{PUSCH,b,f,c} (i, j, q_{d}, l) of the transmit power \hat{P}_{PUSCH,b,f,c}(i, j, q_{d}, l), with parameters as defined in clause 7.1.1 of [TS38213]. For a PUSCH transmission scheduled by a DCI format other than DCI format 0_0, or configured by ConfiguredGrantConfig or semiPersistentOnPUSCH, if txConfig in PUSCH-Config is set to ‘codebook’, if ul-FullPowerTransmission in PUSCH-Config is provided, the UE 102 scales \hat{P}_{PUSCH,b,f,c} (i, j, q_{d}, l) by s where: (i) if ul-FullPowerTransmission in PUSCH-Config is set to fullpowerMode1, and each SRS resource in the SRS-ResourceSet with usage set to ‘codebook’ has more than one SRS port, s is the ratio of a number of antenna ports with non-zero PUSCH transmission power over the maximum number of SRS ports supported by the UE 102 in one SRS resource; (ii) if ul-FullPowerTransmission in PUSCH-Config is set to fullpowerMode2, (iii) s=1 for full power TPMIs reported by the UE 102 (see e.g., 3GPP TS 38.306 v17.4.0 (2023 Mar. 30)), and s is the ratio of a number of antenna ports with non-zero PUSCH transmission power over a number of SRS ports for remaining TPMIs, where the number of SRS ports is associated with an SRS resource indicated by an SRI field in a DCI format scheduling the PUSCH transmission if more than one SRS resource is configured in the SRS-ResourceSet with usage set to ‘codebook’, or indicated by Type 1 configured grant, or the number of SRS ports is associated with the SRS resource if only one SRS resource is configured in the SRS-ResourceSet with usage set to ‘codebook’, (iv) s=1, if an SRS resource with a single port is indicated by an SRI field in a DCI format scheduling the PUSCH transmission when more than one SRS resource is provided in the SRS-ResourceSet with usage set to ‘codebook’, or indicated by Type 1 configured grant, or if only one SRS resource with a single port is provided in the SRS-ResourceSet with usage set to ‘codebook’; and (v) if ul-FullPower Transmission in PUSCH-Config is set to fullpower, s=1; (vi) else, if each SRS resource in the SRS-ResourceSet with usage set to ‘codebook’ has more than one SRS port, the UE 102 scales the linear value by the ratio of the number of antenna ports with a non-zero PUSCH transmission power to the maximum number of SRS ports supported by the UE 102 in one SRS resource. The UE 102 splits the power equally across the antenna ports on which the UE 102 transmits the PUSCH with non-zero power.

### 1.4.1. Transmission Schemes

In 3GPP systems, two transmission schemes are supported for PUSCH transmission, including codebook based transmission and non-codebook based transmission. For codebook based transmission, a radio access network (RAN) node provides a user equipment (UE) with a transmit precoding matrix indication (TPMI) in downlink control information (DCI). The UE 102 uses the TPMI to select the PUSCH transmit precoder from the codebook. For non-codebook based transmission, the UE 102 determines its PUSCH precoder based on wideband sounding reference signals (SRS) resource indicator (SRI) field from the DCI.

A UE 102 is configured with codebook based transmission when the higher layer parameter txConfig in pusch-Config is set to ‘codebook’, the UE 102 is configured non-codebook based transmission when the higher layer parameter txConfig is set to ‘nonCodebook’. If the higher layer parameter txConfig is not configured, the UE 102 is not expected to be scheduled by DCI format 0_1 or 0_2. If PUSCH is scheduled by DCI format 0_0, the PUSCH transmission is based on a single antenna port. Except if the higher layer parameter enableDefaultBeamPL-ForPUSCH0-0 is set ‘enabled’, the UE 702 does not expect PUSCH scheduled by DCI format 0_0 in a bandwidth part (BWP) without configured PUCCH resource with PUCCH-SpatialRelationInfo in frequency range 2 in RRC connected mode.

For codebook based transmission, PUSCH can be scheduled by DCI format 0_0, DCI format 0_1, DCI format 0_2 or semi-statically configured to operate according to clause 6.1.2.3 of [TS38214]. If this PUSCH is scheduled by DCI format 0_1, DCI format 0_2, or semi-statically configured to operate according to clause 6.1.2.3 of [TS38214], the UE 102 determines its PUSCH transmission precoder(s) based on SRI(s), TPMI(s) and the transmission rank, where the SRI(s), TPMI(s) and the transmission rank are given by DCI fields of one or two SRS resource indicators and one or two Precoding information and number of layers in clause 7.3.1.1.2 and 7.3.1.1.3 of [TS38212] for DCI format 0_1 and 0_2 or given by srs-ResourceIndicator and precodingAndNumberOfLayers according to clause 6.1.2.3 of [TS38214] or given by srs-ResourceIndicator, srs-ResourceIndicator2, precodingAndNumberOfLayers, and precodingAndNumberOfLayers2 according to clause 6.1.2.3 of [TS38214]. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one or two SRS resource sets can be configured in srs-ResourceSetToAddModList with higher layer parameter usage in SRS-ResourceSet set to ‘codebook’, and only one or two SRS resource sets can be configured in srs-ResourceSetToAddModListDCI-0-2 with higher layer parameter usage in SRS-ResourceSet set to ‘codebook’.

When only one SRS resource set is configured in srs-ResourceSetToAddModList or srs-ResourceSetToAddModListDCI-0-2 with higher layer parameter usage in SRS-ResourceSet set to ‘codebook’, SRI and TPMI are given by the DCI fields of one SRS resource indicator and one Precoding information and number of layers in clause 7.3.1.1.2 and 7.3.1.1.3 of [TS38212] for DCI format 0_1 and 0_2 or given by srs-ResourceIndicator and precodingAndNumberOfLayers according to clause 6.1.2.3 of [TS38214]. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [TS38211]. When the UE 102 is configured with the higher layer parameter txConfig set to ‘codebook’, the UE 102 is configured with at least one SRS resource. The indicated SRI in slot n is associated with the most recent transmission of SRS resource identified by the SRI, where the SRS resource is prior to the PDCCH carrying the SRI.

When two SRS resource sets are configured in srs-ResourceSetToAddModList or srs-ResourceSetToAddModListDCI-0-2 with higher layer parameter usage in SRS-ResourceSet set to ‘codebook’, one or two SRI(s), and one or two TPMI(s) are given by the DCI fields of two SRS resource indicator and two Precoding information and number of layers in clause 7.3.1.1.2 and 7.3.1.1.3 of [TS38212] for DCI format 0_1 and 0_2. The UE 102 applies the indicated SRI(s) and TPMI(s) to one or more PUSCH repetitions according to the associated SRS resource set of a PUSCH repetition according to clause 6.1.2.1 of [TS38214]. Each TPMI, based on indicated codepoint of SRS Resource Set indicator, is used to indicate the precoder to be applied over the layers {0 . . . v−1} and that corresponds to the SRS resource selected by the corresponding SRI when multiple SRS resources are configured for the applicable SRS resource set, or if a single SRS resource is configured for the applicable SRS resource set TPMI is used to indicate the precoder to be applied over the layers {0 . . . v−1} and that corresponds to the SRS resource. For one or two TPMI(s), the transmission precoder is selected from the uplink codebook that has a number of antenna ports equal to the higher layer parameter nrofSRS-Ports in SRS-Config for the indicated SRI(s), as defined in clause 6.3.1.5 of [TS38211]. When two SRIs are indicated, the UE 102 expects the nrofSRS-Ports for the two indicated SRS resources to be the same. When the UE 702 is configured with the higher layer parameter txConfig set to ‘codebook’, the UE 102 is configured with at least one SRS resource. Each of the indicated one or two SRI(s) in slot n is associated with the most recent transmission of SRS resource of associated SRS resource set identified by the SRI, where the SRS resource is prior to the PDCCH carrying the SRI. When two SRS resource sets are configured in srs-ResourceSetToAddModList or srs-ResourceSetToAddModListDCI-0-2 with higher layer parameter usage in SRS-ResourceSet set to ‘codebook’, the UE 102 is not expected to be configured with different number of SRS resources in the two SRS resource sets.

When the PDCCH reception includes two PDCCH candidates from two respective search space sets, as described in clause 10.1 of [TS38213], for the purpose of determining the most recent transmission of SRS resource identified by the SRI, the PDCCH candidate that starts earlier in time is used.

For codebook based transmission, the UE 102 determines its codebook subsets based on TPMI(s) and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’, or ‘nonCoherent’ depending on the UE 102 capability. When higher layer parameter ul-FullPowerTransmission is set to ‘fullpowerMode2’ and the higher layer parameter codebookSubset or the higher layer parameter codebookSubsetDCI-0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRankDCI-0-2 for PUSCH scheduled with DCI format 0_2.

A UE 102 reporting its UE capability of ‘partialAndNonCoherent’ transmission does not expect to be configured by either codebookSubset or codebookSubsetDCI-0-2 with ‘fullyAndPartialAndNonCoherent’. A UE 102 reporting its UE capability of ‘nonCoherent’ transmission does not expect to be configured by either codebookSubset or codebookSubsetDCI-0-2 with ‘fullyAndPartialAndNonCoherent’ or with ‘partialAndNonCoherent’. A UE 102 does not expect to be configured with the higher layer parameter codebookSubset or the higher layer parameter codebookSubsetDCI-0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE 102, the SRS request field in DCI triggers the transmission of aperiodic SRS resources.

A UE 102 does not expect to be configured with higher layer parameter ul-FullPowerTransmission set to ‘fullpowerMode1’ and codebookSubset or codebookSubsetDCI-0-2 set to ‘fullAndPartialAndNonCoherent’ simultaneously.

The UE 102 transmits PUSCH using the same antenna port(s) as the SRS port(s) in the SRS resource indicated by the DCI format 0_1 or 0_2 or by configuredGrantConfig according to clause 6.1.2.3 of [TS38214].

The DM-RS antenna ports {\tilde{p}_{0, . . . ,}\tilde{p}ᵥ₋₁} in Clause 6.4.1.1.3 of [TS38211] are determined according to the ordering of DM-RS port(s) given by Tables 7.3.1.1.2-6 to 7.3.1.1.2-23 in Clause 7.3.1.1.2 of [TS38212].

Except when higher layer parameter ul-FullPowerTransmission is set to ‘fullpowerMode2’, when multiple SRS resources are configured by SRS-ResourceSet with usage set to ‘codebook’, the UE 102 expects that higher layer parameters nrofSRS-Ports in SRS-Resource in SRS-ResourceSet is configured with the same value for all these SRS resources.

When higher layer parameter ul-FullPower Transmission is set to ‘fullpowerMode2’, the UE 102 can be configured with one SRS resource or multiple SRS resources with same or different number of SRS ports within an SRS resource set with usage set to ‘codebook’. When higher layer parameter ul-FullPowerTransmission is set to ‘fullpowerMode2’, up to 2 different spatial relations can be configured for all SRS resources in the SRS resource set with usage set to ‘codebook’ when multiple SRS resources are configured in the SRS resource set. Subject to UE 102 capability, a maximum of 2 or 4 SRS resources are supported in an SRS resource set with usage set to ‘codebook’.

For non-codebook based transmission, PUSCH can be scheduled by DCI format 0_0, DCI format 0_1, DCI format 0_2 or semi-statically configured to operate according to [TS38214]§ 6.1.2.3. If this PUSCH is scheduled by DCI format 0_1, DCI format 0_2, or semi-statically configured to operate according to [TS38214]§ 6.1.2.3, the UE 102 can determine its PUSCH precoder(s) and transmission rank based on the SRI(s) when multiple SRS resources are configured, where the SRI(s) is given by one or two SRS resource indicator(s) in DCI according to clause 7.3.1.1.2 and 7.3.1.1.3 of [TS38212] for DCI format 0_1 and DCI format 0_2, or the SRI is given by srs-ResourceIndicator according to [TS38214]§ 6.1.2.3, or SRIs given by srs-ResourceIndicator and srs-ResourceIndicator2 according to [TS38214]§ 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The UE 102 shall use one or multiple SRS resources for SRS transmission, where, in a SRS resource set, the maximum number of SRS resources which can be configured to the UE 102 for simultaneous transmission in the same symbol and the maximum number of SRS resources are UE capabilities. The SRS resources transmitted simultaneously occupy the same RBs. Only one SRS port for each SRS resource is configured. Only one or two SRS resource sets can be configured in srs-ResourceSetToAddModList with higher layer parameter usage in SRS-ResourceSet set to ‘nonCodebook’, and only one or two SRS resource sets can be configured in srs-ResourceSetToAddModListDCI-0-2 with higher layer parameter usage in SRS-ResourceSet set to ‘nonCodebook’. When two SRS resource sets are configured in srs-ResourceSetToAddModList or srs-ResourceSetToAddModListDCI-0-2 with higher layer parameter usage in SRS-ResourceSet set to ‘nonCodebook’, SRIs are given by the DCI fields of two SRS resource indicators in [TS38212] §§ 7.3.1.1.2, 7.3.1.1.3 for DCI format 0_1 and 0_2. The UE 102 applies the indicated SRI(s) to one or more PUSCH repetitions according to the associated SRS resource set of a PUSCH repetition according to [TS38214]§ 6.1.2.1. The maximum number of SRS resources per SRS resource set that can be configured for non-codebook based uplink transmission is 4. Each of the indicated SRIs in slot n is associated with the most recent transmission of SRS resource(s) of associated SRS resource set identified by the SRI, where the SRS transmission is prior to the PDCCH carrying the SRI. When two SRS resource sets are configured in srs-ResourceSetToAddModList or srs-ResourceSetToAddModListDCI-0-2 with higher layer parameter usage in SRS-ResourceSet set to ‘nonCodebook’, the UE 102 is not expected to be configured with different number of SRS resources in the two SRS resource sets.

When the PDCCH reception includes two PDCCH candidates from two respective search space sets, as described in [TS38213]§ 10.1, for the purpose of determining the most recent transmission of SRS resource(s) identified by the SRI, the PDCCH candidate that starts earlier in time is used.

For non-codebook based transmission, the UE 102 can calculate the precoder used for the transmission of SRS based on measurement of an associated NZP CSI-RS resource. The UE 102 can be configured with only one NZP CSI-RS resource for each of the SRS resource set(s) with higher layer parameter usage in SRS-ResourceSet set to ‘nonCodebook’ if configured.

If aperiodic SRS resource set is configured, the associated NZP-CSI-RS is indicated via SRS request field in DCI format 0_1 and 1_1, as well as DCI format 0_2 (if SRS request field is present) and DCI format 1_2 (if SRS request field is present), where AperiodicSRS-Resource Trigger and AperiodicSRS-ResourceTriggerList (indicating the association between aperiodic SRS triggering state(s) and SRS resource sets), triggered SRS resource(s) srs-ResourceSetId, csi-RS (indicating the associated NZP-CSI-RS-ResourceId) are higher layer configured in SRS-ResourceSet. The SRS-ResourceSet(s) associated with the SRS request by DCI format 0_1 and 1_1 are defined by the entries of the higher layer parameter srs-ResourceSetToAddModList and the SRS-Resource Set(s) associated with the SRS request by DCI format 0_2 and 1_2 are defined by the entries of the higher layer parameter srs-ResourceSetToAddModListDCI-0-2. A UE 102 is not expected to update the SRS precoding information if the gap from the last symbol of the reception of the aperiodic NZP-CSI-RS resource and the first symbol of the aperiodic SRS transmission is less than 42·2^{max(0,μ-3)} OFDM symbols, where the SCS configuration u is the smallest SCS configuration between the NZP-CSI-RS resource and the SRS transmission.

If the UE 102 configured with aperiodic SRS associated with aperiodic NZP CSI-RS resource, the presence of the associated CSI-RS is indicated by the SRS request field if the value of the SRS request field is not ‘00’ as in Table 7.3.1.1.2-24 of [TS38212] and if the scheduling DCI is not used for cross carrier or cross bandwidth part scheduling. If the UE 102 is configured with minimumSchedulingOffsetK0 in the active DL BWP and the currently applicable minimum scheduling offset restriction K_{0,min} is larger than 0, the UE 102 does not expected to receive the scheduling DCI with the SRS request field value other than ‘00’. The CSI-RS is located in the same slot as the SRS request field. If the UE 102 is configured with aperiodic SRS associated with aperiodic NZP CSI-RS resource, any of the TCI states configured in the scheduled CC shall not be configured with qcl-Type set to ‘typeD’.

If periodic or semi-persistent SRS resource set is configured, the NZP-CSI-RS-ResourceId for measurement is indicated via higher layer parameter associatedCSI-RS in SRS-ResourceSet.

The UE 102 performs one-to-one mapping from the indicated SRI(s) to the indicated DM-RS ports(s) and their corresponding PUSCH layers {0 . . . v−1} given by DCI format 0_1 or 0_2 or by configuredGrantConfig according to [TS38214]§ 6.1.2.3 in increasing order.

The UE 102 transmits PUSCH using the same antenna ports as the SRS port(s) in the SRS resource(s) indicated by SRI(s) given by DCI format 0_1 or 0_2 or by configuredGrantConfig according to [TS38214]§ 6.1.2.3, where the SRS port in (i+1)-th SRS resource in the SRS resource set is indexed as pᵢ=1000+i.

The DM-RS antenna ports {\tilde{p}_{0, . . . ,}\tilde{p}ᵥ₋₁} in [TS38211]§ 6.4.1.1.3 are determined according to the ordering of DM-RS port(s) given by Tables 7.3.1.1.2-6 to 7.3.1.1.2-23 in clause 7.3.1.1.2 of [TS38212].

For non-codebook based transmission, the UE 102 does not expect to be configured with both spatialRelationInfo for SRS resource and associatedCSI-RS in SRS-ResourceSet for SRS resource set. For non-codebook based transmission, the UE 102 can be scheduled with DCI format 0_1 or 0_2 when at least one SRS resource is configured in SRS-ResourceSet with usage set to ‘nonCodebook’.

### 1.5. Ue Procedure for Reporting Channel State Information (CSI)

### 1.5.1. CSI Framework

The procedures on aperiodic CSI reporting described herein and/or in [TS38214] assume that the CSI reporting is triggered by DCI format 0_1, but they equally apply to CSI reporting triggered by DCI format 0_2 and/or other DCI formats, by applying the higher layer parameter reportTriggerSizeDCI-0-2 instead of reportTriggerSize. The time and frequency resources that can be used by the UE 102 to report CSI are controlled by a RAN node (e.g., gNB 716 and/or the like). CSI may include Channel Quality Indicator (CQI), precoding matrix indicator (PMI), CSI-RS resource indicator (CRI), SS/PBCH Block Resource indicator (SSBRI), layer indicator (L1), rank indicator (RI), L1-RSRP, L1-SINR, and/or CapabilityIndex. For CQI, PMI, CRI, SSBRI, L1, RI, L1-RSRP, L1-SINR, and/or CapabilityIndex, the UE 102 is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig. Additional aspects of CQI, PMI, CSI-RS, CSI-IM, and CSI reference resources are discussed in [TS38214].

Each Reporting Setting CSI-ReportConfig is associated with a single downlink bandwidth part (BWP) indicated by higher layer parameter BWP-Id given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE 102 such as the layer indicator (L1), L1-RSRP, L1-SINR, CRI, and SSBRI (SSB Resource Indicator) and CapabilityIndex. The time domain behavior of the CSI-ReportConfig is indicated by the higher layer parameter report ConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related or CapabilityIndex-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II, Enhanced Type II CSI, or Further Enhanced Type II Port Selection including codebook subset restriction when applicable, and configurations of group-based reporting. A UE 102 is not expected to be configured with a CSI report setting associated with a dormant DL BWP if the report ConfigType is set to ‘aperiodic’.

Each CSI Resource Setting CSI-ResourceConfig contains a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI Resource Setting is located in the DL BWP identified by the higher layer parameter BWP-id, and all CSI Resource Settings linked to a CSI Report Setting have the same DL BWP.

The time domain behavior of the CSI-RS resources within a CSI resource setting are indicated by the higher layer parameter resource Type and can be set to aperiodic, periodic, or semi-persistent. For periodic and semi-persistent CSI Resource Settings, when the UE 102 is configured with groupBasedBeamReporting-r17, the number of CSI Resource Sets configured is S=2, otherwise the number of CSI-RS Resource Sets configured is limited to S=1. For periodic and semi-persistent CSI Resource Settings, the configured periodicity and slot offset is given in the numerology of its associated DL BWP, as given by BWP-id. When a UE 102 is configured with multiple CSI-ResourceConfigs including the same NZP CSI-RS resource ID, the same time domain behavior is configured for the CSI-ResourceConfigs. When a UE 102 is configured with multiple CSI-ResourceConfigs including the same CSI-IM resource ID, the same time domain behavior is configured for the CSI-ResourceConfigs. All CSI resource settings linked to a CSI report setting have the same time domain behavior.

The UE 102 can be configured via higher layer signaling for one or more CSI resource settings for channel and interference measurement, which include one or more of: CSI-Interference Measurement (CSI-IM) resource(s) for interference measurement as described in clause 5.2.2.4 of [TS38214]; non-zero power (NZP) CSI-RS resource(s) for interference measurement as described in clause 5.2.2.3.1 of [TS38214]; and NZP CSI-RS resource(s) for channel measurement as described in clause 5.2.2.3.1 of [TS38214].

The UE 102 calculates CSI parameters (if reported) assuming the following dependencies between CSI parameters (if reported): L1 is calculated conditioned on the reported CQI, PMI, RI and CRI; CQI is calculated conditioned on the reported PMI, RI and CRI; PMI is calculated conditioned on the reported RI and CRI; and RI is calculated conditioned on the reported CRI. The reporting configuration for CSI can be aperiodic (e.g., using PUSCH), periodic (e.g., using PUCCH), or semi-persistent (e.g., using PUCCH, and DCI activated PUSCH). The CSI-RS resources can be periodic, semi-persistent, or aperiodic. In one example, the UE 102 supports combinations of CSI reporting configurations and CSI-RS resource configurations, and how the CSI reporting is triggered for each CSI-RS resource configuration, as shown by table 5.2.1.4-1 in [TS38214].

Periodic CSI-RS is configured by higher layers. When the CSI-RS configuration is periodic CSI-RS, there is no dynamic triggering/activation for periodic CSI reporting. With respect to semi-persistent CSI reporting, the UE 102 receives an activation command as described in clause 6.1.3.16 of [TS38321] for reporting on PUCCH; and the UE 102 receives triggering on DCI for reporting on PUSCH. Semi-persistent CSI-RS is activated and deactivated as described in clause 5.2.1.5.2 of [TS38214]. When the CSI-RS configuration is semi-persistent CSI-RS, periodic CSI reporting is not supported. With respect to semi-persistent CSI reporting, the UE 102 receives an activation command as described in clause 6.1.3.16 of [TS38321] for reporting on PUCCH; and the UE 102 receives triggering on DCI for reporting on PUSCH. Aperiodic CSI-RS is configured and triggered/activated as described in clause 5.2.1.5.1 of [TS38214]. When the CSI-RS configuration is aperiodic CSI-RS, periodic CSI reporting and semi-persistent CSI reporting are not supported. Aperiodic CSI reporting (for each I-RS configuration type) is triggered by DCI; additionally, subselection indication as described in clause 6.1.3.13 of [TS38321] possible as defined in clause 5.2.1.5.1 of [TS38214]. Additional aspects of report configurations, resource setting configurations, L1-RSRP report configurations, L1-SINR report configurations, and triggering/activation of CSI reports and CSI-RS are discussed in [TS38214].

### 1.5.2. CSI Reporting Using Pusch

The UE 102 performs aperiodic CSI reporting using PUSCH on serving cell c upon successful decoding of a DCI format 0_1 or DCI format 0_2 which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

An aperiodic CSI report carried on the PUSCH supports wideband, and sub-band frequency granularities. An aperiodic CSI report carried on the PUSCH supports Type I, Type II, Enhanced Type II and Further Enhanced Type II Port Selection CSI.

The UE 102 performs semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. Semi-persistent CSI reporting on the PUSCH supports Type I, Type II with wideband, and sub-band frequency granularities, Enhanced Type II and Further Enhanced Type II Port Selection CSI. The PUSCH resources and MCS shall be allocated semi-persistently by an uplink DCI.

CSI reporting on PUSCH can be multiplexed with uplink data on PUSCH except that semi-persistent CSI reporting on PUSCH activated by a DCI format is not expected to be multiplexed with uplink data on the PUSCH. CSI reporting on PUSCH can also be performed without any multiplexing with uplink data from the UE.

Type I CSI feedback is supported for CSI Reporting on PUSCH. Type I wideband and sub-band CSI is supported for CSI Reporting on the PUSCH. Type II CSI is supported for CSI Reporting on the PUSCH.

For Type I, Type II, Enhanced Type II and Further Enhanced Type II Port Selection CSI feedback on PUSCH, a CSI report comprises of two parts. Part 1 has a fixed payload size and is used to identify the number of information bits in Part 2. Part 1 is transmitted in its entirety before Part 2.

For Type I CSI feedback, Part 1 contains RI (if reported), CRI (if reported), CQI for the first codeword (if reported). Part 2 contains PMI (if reported), L1 (if reported) and contains the CQI for the second codeword (if reported) when RI is larger than 4. For a CSI-ReportConfig configured with codebookType set to ‘typeI-SinglePanel’ and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

For Type II CSI feedback, Part 1 contains RI (if reported), CQI, and an indication of the number of non-zero wideband amplitude coefficients per layer for the Type II CSI (see e.g., clause 5.2.2.2.3 of [TS38214]). The fields of Part 1—RI (if reported), CQI, and the indication of the number of non-zero wideband amplitude coefficients for each layer—are separately encoded. Part 2 contains the PMI and L1 (if reported) of the Type II CSI. The elements of i_{1,4,l}, i_{2,1,l} (if reported) and i_{2,2,l} (if reported) are reported in the increasing order of their indices, i=0,1, . . . , 2L−1, where the element of the lowest index is mapped to the most significant bits and the element of the highest index is mapped to the least significant bits. Part 1 and 2 are separately encoded.

For Enhanced Type II CSI feedback (see e.g., clause 5.2.2.2.5 of [TS38214]) and Further Enhanced Type II Port Selection CSI feedback (see e.g., clause 5.2.2.2.7 of [TS38214]), Part 1 contains RI (if reported), CQI, and an indication of the overall number of non-zero amplitude coefficients across layers. The fields of Part 1—RI (if reported), CQI, and the indication of the overall number of non-zero amplitude coefficients across layers—are separately encoded. Part 2 contains the PMI of the Enhanced Type II or Further Enhanced Type II Port Selection CSI. Part 1 and 2 are separately encoded.

A Type II CSI report that is carried on the PUSCH shall be computed independently from any Type II CSI report that is carried on the PUCCH formats 3 or 4 (see e.g., clause 5.2.4 and 5.2.2 of [TS38214]).

When the higher layer parameter reportQuantity is configured with one of the values ‘cri-RSRP’, ‘ssb-Index-RSRP’, ‘cri-SINR’ or ‘ssb-Index-SINR’, or ‘cri-RSRP-Index’, ‘ssb-Index-RSRP-Index’, ‘cri-SINR-Index’, ‘ssb-Index-SINR-Index’, the CSI feedback includes a single part.

For both Type I and Type II reports configured for PUCCH but transmitted on PUSCH, the determination of the payload for CSI part 1 and CSI part 2 follows that of PUCCH as described in clause 5.2.4 of [TS38214].

When CSI reporting on PUSCH comprises two parts, the UE 102 may omit a portion of the Part 2 CSI. Omission of Part 2 CSI is according to the priority order shown in Table 1.5.2-1, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{i,CSI}(y,k,c,s) value among the N_{Rep} CSI reports as defined in Clause 5.2.5. The subbands for a given CSI report n indicated by the higher layer parameter csi-ReportingBand with value ‘1’ are numbered continuously in increasing order with the lowest subband of csi-ReportingBand with value set to ‘1’ as subband 0. When omitting Part 2 CSI information for a particular priority level, the UE 102 omits all of the information at that priority level.

For Enhanced Type II reports, for a given CSI report n, each reported element of indices i_{2,4,l} i_{2,5,l} and i_{1,7,l}, indexed by l, i and f, is associated with a priority value Pri(l, i, f)=2·L·v·π(f)+v·i+l, with π(f)=min(2·n_{3,l}^{(f)}, 2·(N₃-n_{3,l}^{(f)})−1) with l=1, 2, . . . , v, i=0,1, . . . ,2L−1, and f=0,1, . . . , Mᵥ−1, and where n_{3,l}^{(f)} is defined in clause 5.2.2.2.5 of [TS38214]. The element with the highest priority has the lowest associated value Pri(l, i, f). Omission of Part 2 CSI is according to the priority order shown in Table 1.5.2-1, where: Group 0 includes indices i_{1,1} (if reported), i_{1,2} (if reported) and i_{1,8,1} (l=1, . . . , v); Group 1 includes indices i_{1,5} (if reported), i_{1,6,1} (if reported), the v2LMᵥ−[K^{NZ}/2] highest priority elements of i_{1,7,l}, i_{2,3,l}, the

$$max ( 0 , ⌈ \frac{{K}^{NZ}}{2} ⌉ - υ )$$

highest priority elements of i_{2,4,l} and the

$$max ( 0 , ⌈ \frac{{K}^{NZ}}{2} ⌉ - υ )$$

highest priority elements of i_{2,5,l} (l=1, . . . , v); and Group 2 includes the [K^{NZ}/2] lowest priority elements of i_{1,7,l}, the

$$min ( {K}^{NZ} - v , ⌊ \frac{{K}^{NZ}}{2} ⌋ )$$

lowest priority elements of i_{2,4,l} and the

$$min ( {K}^{NZ} - v , ⌊ \frac{{K}^{NZ}}{2} ⌋ )$$

lowest priority elements of i_{2,5,l} (l=1, . . . , v).

For Further Enhanced Type II Port Selection reports, for a given CSI report n, each reported element of i_{2,4,l} i_{2,5,l} and i_{1,7,l}, indexed by l, i and f, is associated with a priority value Pri(l, i, f)=K₁·v·f+v·i+l, with l=1, 2, . . . , v, i=0,1, . . . , K₁−1 and f=0, . . . , M−1. The element with the highest priority has the lowest associated value Pri(l, i, f). Omission of Part 2 CSI is according to the priority order shown in Table 1.5.2-1, where: Group 0 includes i_{1,2} (if reported), i_{1,8,l} (l=1, . . . , v) and i_{1,6} (if reported); Group 1 includes the vK₁M−[K^{NZ}/2] highest priority elements of i_{1,7,l} (if reported), i_{2,3,l}, the

$$max ( 0 , ⌊ \frac{{K}^{NZ}}{2} ⌋ - υ )$$

highest priority elements of i_{2,4,l} and the

$$max ( 0 , ⌊ \frac{{K}^{NZ}}{2} ⌋ - υ )$$

highest priority elements of i_{2,5,l} (l=1, . . . , v); and Group 2 includes the [K^{NZ}/2] lowest priority elements of i_{1,7,l} (if reported), the

$$min ( {K}^{NZ} - v , ⌊ \frac{{K}^{NZ}}{2} ⌋ )$$

lowest priority elements of i_{2,4,l} and the

$$min ( {K}^{NZ} - v , ⌊ \frac{{K}^{NZ}}{2} ⌋ )$$

lowest priority elements of i_{2,5,l} (l=1, . . . , v).

TABLE 1.5.2-1
Priority reporting levels for Part 2 CSI

Priority 0: For CSI reports 1 to N_{Rep}, Group 0 CSI for CSI
reports configured as ‘typeII-r16’, ‘typeII-PortSelection-r16’ or
‘typeII-PortSelection-r17’; Part 2 wideband CSI for CSI reports
configured otherwise
Priority 1: Group 1 CSI for CSI report 1, if configured as ‘typeII-
r16’, ‘typeII-PortSelection-r16’ or ‘typeII-PortSelection-r17’; Part
2 subband CSI of even subbands for CSI report 1, if configured
otherwise
Priority 2: Group 2 CSI for CSI report 1, if configured as ‘typeII-
r16’, ‘typeII-PortSelection-r16’ or ‘typeII-PortSelection-r17’; Part
2 subband CSI of odd subbands for CSI report 1, if configured
otherwise
Priority 3: Group 1 CSI for CSI report 2, if configured as ‘typeII-
r16’, ‘typeII-PortSelection-r16’ or ‘typeII-PortSelection-r17’; Part
2 subband CSI of even subbands for CSI report 2, if configured
otherwise
Priority 4: Group 2 CSI for CSI report 2, if configured as ‘typeII-
r16’, ‘typeII-PortSelection-r16’ or ‘typeII-PortSelection-r17’. Part
2 subband CSI of odd subbands for CSI report 2, if configured
otherwise
.
.
.
Priority 2N_{Rep} − 1: Group 1 CSI for CSI report N_{Rep}, if
configured as ‘typeII-r16’, ‘typeII-PortSelection-r16’ or ‘typeII-
PortSelection-r17’; Part 2 subband CSI of even subbands for
CSI report N_{Rep}, if configured otherwise
Priority 2N_{Rep}: Group 2 CSI for CSI report N_{Rep}, if configured
as ‘typeII-r16’, ‘typeII-PortSelection-r16’ or ‘typeII-
PortSelection-r17’; Part 2 subband CSI of odd subbands for
CSI report N_{Rep}, if configured otherwise

When the UE 102 is scheduled to transmit a transport block on PUSCH not using repetition type B multiplexed with a CSI report(s), Part 2 CSI is omitted only when:

$$⌈ ( {O}_{CSI - 2} + {L}_{CSI - 2} ) \cdot {β}_{offset}^{PUSCH} \cdot {\sum }_{I = 0}^{{N}_{symb , all}^{PUSCH} - 1} {M}_{sc}^{UCI} ( l ) / {\sum }_{r = 0}^{{C}_{UL - SCH} - 1} {K}_{r} ⌉$$

is larger than

$$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} ,$$

where parameters O_{CSI-2}, L_{CSI-2}, β_{offset}^{PUSCH}, N_{symball}^{PUSCH}, M_{sc}^{UCI}(l), C_{UL-SCH}, Kᵣ, Q′_{CSI-1}, Q′_{ACK/CG-UCI} and α are defined in clause 6.3.2.4 of [TS38212].

Part 2 CSI is omitted level by level, beginning with the lowest priority level until the lowest priority level is reached which causes the

$$⌈ ( {O}_{CSI - 2} + {L}_{CSI - 2} ) \cdot {β}_{offset}^{PUSCH} \cdot {\sum }_{I = 0}^{{N}_{symb , all}^{PUSCH} - 1} {M}_{sc}^{UCI} ( l ) / {\sum }_{r = 0}^{{C}_{UL - SCH} - 1} {K}_{r} ⌉$$

to be less than or equal to ┌α·Σₗ₌₀^{N}^{_{symb,all}}^{^{PUSCH}}⁻¹ M_{sc}^{UCI}(l)┐−Q′_{ACK/CG-UCI}−Q′_{CSI-1}.

When the UE 102 is scheduled to transmit a transport block on PUSCH using repetition type B multiplexed with a CSI report(s), Part 2 CSI is omitted only when:

$$⌈ ( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc , nominal}^{UCI} ( l ) / {\sum }_{r = 0}^{{C}_{UL - SCH} - 1} {K}_{r} ⌉$$

is larger than

$$min \{ \begin{matrix}⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′}\end{matrix} \} ,$$

where parameters O_{CSI-2}, L_{CSI-2}, β_{offset}^{PUSCH}, N_{symb,nominal}^{PUSCH}, N_{symb,actual}^{PUSCH}, M_{sc,nominal}^{UCI}(l), M_{sc,actual}^{UCI}(l), C_{UL-SCH}, Kᵣ, Q′_{ACK/CG-UCI}, Q′_{CSI-1}, and α are defined in clause 6.3.2.4 of [TS38212].

Part 2 CSI is omitted level by level, beginning with the lowest priority level until the lowest priority level is reached which causes

$$⌈ ( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l ) / {\sum }_{r = 0}^{{C}_{UL - SCH} - 1} {K}_{r} ⌉$$

to be less than or equal to:

$$min \{ \begin{matrix}⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′}\end{matrix} \} .$$

When part 2 CSI is transmitted on PUSCH with no transport block, lower priority bits are omitted until Part 2 CSI code rate, which is given by (O_{CSI-2}+L_{CSI-2})/(N_{L}·Q′_{CSI-2}·Qₘ) where O_{CSI-2}, L_{CSI-2}, N_{L}, Q′_{CSI-2}, Qₘ are given in clause 6.3.2.4 of [5, 38.212] before HARQ-ACK puncturing part 2 CSI if any, is below a threshold code rate c_{T} lower than one, where

$${c}_{T} = \frac{R}{{β}_{offset}^{CSI - part 2}} ,$$

wherein β_{offset}^{CSI-part2} is the CSI offset value from Table 9.3-2 of [TS38213], and R is signaled code rate in DCI.

If the UE 102 is in an active semi-persistent CSI reporting configuration on PUSCH, the CSI reporting is deactivated when either the downlink BWP or the uplink BWP is changed. Another activation command is required to enable the semi-persistent CSI reporting.

### 1.5.3. CSI Reporting Using Pucch

A UE 102 is semi-statically configured by higher layers to perform periodic CSI reporting on the PUCCH. The UE 102 can be configured by higher layers for multiple periodic CSI reports corresponding to multiple higher layer configured CSI reporting settings, where the associated CSI resource settings are higher layer configured. Periodic CSI reporting on PUCCH formats 2, 3, 4 supports Type I CSI with wideband granularity.

The UE 102 performs semi-persistent CSI reporting on the PUCCH applied starting from the first slot that is after slot n+3Nₛₗₒₜ^{subframe,μ} when the UE 102 would transmit a PUCCH with HARQ-ACK information in slot n corresponding to the PDSCH carrying the activation command described in clause 6.1.3.16 of [TS38321] where μ is the SCS configuration for the PUCCH. The activation command will contain one or more Reporting Settings where the associated CSI Resource Settings are configured. Semi-persistent CSI reporting on the PUCCH supports Type I CSI. Semi-persistent CSI reporting on the PUCCH format 2 supports Type I CSI with wideband frequency granularity. Semi-persistent CSI reporting on PUCCH formats 3 or 4 supports Type I CSI with wideband and sub-band frequency granularities and Type II CSI Part 1.

When the PUCCH carry Type I CSI with wideband frequency granularity, the CSI payload carried by the PUCCH format 2 and PUCCH formats 3, or 4 are identical and the same irrespective of RI (if reported), CRI (if reported). A CSI-ReportConfig with codebookType set to ‘typeI-SinglePanel’ and the corresponding CSI-RS Resource Set for channel measurement configured with two Resource Groups and N Resource Pairs can be configured with wideband frequency granularity only with esi-ReportMode set to ‘Mode1’ and numberOfSingleTRP-CSI-Mode 1 set to X=0. For type I CSI sub-band reporting on PUCCH formats 3, or 4, the payload is split into two parts. The first part contains RI (if reported), CRI (if reported), CQI for the first codeword. The second part contains PMI (if reported), L1 (if reported) and contains the CQI for the second codeword (if reported) when RI>4. For a CSI-ReportConfig configured with subband reporting, codebookType set to ‘typeI-SinglePanel’ and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

A semi-persistent report carried on the PUCCH formats 3 or 4 supports Type II CSI feedback, but only Part 1 of Type II CSI feedback (See Clause 5.2.2 and 5.2.3). Supporting Type II CSI reporting on the PUCCH formats 3 or 4 is a UE capability type2-SP-CSI-Feedback-LongPUCCH. A Type II CSI report (Part 1 only) carried on PUCCH formats 3 or 4 shall be calculated independently of any Type II CSI reports carried on the PUSCH (see Clause 5.2.3).

When the UE 102 is configured with CSI Reporting on PUCCH formats 2, 3 or 4, each PUCCH resource is configured for each candidate UL BWP.

If the UE 102 is in an active semi-persistent CSI reporting configuration on PUCCH and has not received a deactivation command, the CSI reporting takes place when the BWP in which the reporting is configured to take place is the active BWP, otherwise the CSI reporting is suspended.

The UE 102 is not expected to report CSI with a total number of UCI bits and CRC bits larger than 115 bits when configured with PUCCH format 4. For CSI reports transmitted on a PUCCH, if all CSI reports includes one part, the UE 102 may omit a portion of CSI reports. Omission of CSI is according to the priority order determined from the Pri_{i,CSI}(y,k,c,s) value as defined in clause 5.2.5 of [TS38214]. CSI report is omitted beginning with the lowest priority level until the CSI report code rate is less or equal to the one configured by the higher layer parameter maxCodeRate.

If any of the CSI reports includes two parts, the UE 102 may omit a portion of Part 2 CSI. Omission of Part 2 CSI is according to the priority order shown in Table 1.5.2-1. Part 2 CSI is omitted beginning with the lowest priority level until the Part 2 CSI code rate is less or equal to the one configured by higher layer parameter maxCodeRate.

### 1.5.4. UE CSI Computation Time

When the CSI request field on (or in) a DCI triggers a CSI report(s) on PUSCH, the UE 102 provides a valid CSI report for the n-th triggered report, (i) if the first uplink symbol to carry the corresponding CSI report(s) including the effect of the timing advance, starts no earlier than at symbol Z_{ref}, and (ii) if the first uplink symbol to carry the n-th CSI report including the effect of the timing advance, starts no earlier than at symbol Z′_{ref}(n), where Z_{ref} is defined as the next uplink symbol with its CP starting T_{proc,CSI}=(Z)(2048+144)·κ2^{-μ}·T_{c}+T_{switch} after the end of the last symbol of the PDCCH triggering the CSI report(s), and where Z′_{ref}(n), is defined as the next uplink symbol with its CP starting T′_{proc,CSI}=(Z′)(2048+144)·κ2^{-μ}·T_{c} after the end of the last symbol in time of the latest of: aperiodic CSI-RS resource for channel measurements, aperiodic CSI-IM used for interference measurements, and aperiodic NZP CSI-RS for interference measurement, when aperiodic CSI-RS is used for channel measurement for the n-th triggered CSI report, and where T_{switch} is defined in clause 6.4 of [TS38214] and is applied only if Z₁ of Table 1.5.4-1 is applied.

If the PUSCH indicated by the DCI is overlapping with another PUCCH or PUSCH, then the CSI report(s) are multiplexed following the procedure in clause 9.2.5 of [TS38213] and clause 5.2.5 of [TS38214] when applicable, otherwise the CSI report(s) are transmitted on the PUSCH indicated by the DCI.

When the CSI request field on a DCI triggers a CSI report(s) on PUSCH, if the first uplink symbol to carry the corresponding CSI report(s) including the effect of the timing advance, starts earlier than at symbol Z_{ref}, the UE 102 may ignore the scheduling DCI if no HARQ-ACK or transport block is multiplexed on the PUSCH.

When the CSI request field on a DCI triggers a CSI report(s) on PUSCH, if the first uplink symbol to carry the n-th CSI report including the effect of the timing advance, starts earlier than at symbol Z′_{ref}(n), the UE 102 may ignore the scheduling DCI if the number of triggered reports is one and no HARQ-ACK or transport block is multiplexed on the PUSCH; otherwise, the UE 102 is not required to update the CSI for the n-th triggered CSI report.

When the PDCCH reception includes two PDCCH candidates from two respective search space sets, as described in clause 10.1 of [TS38213], for the purpose of determining the last symbol of the PDCCH triggering the CSI report(s), the PDCCH candidate that ends later in time is used.

Z, Z′ and μ are defined as follows:

$$Z = {max}_{m = 0 , … , M - 1} ( Z ( m ) ) and {Z}^{′} = {max}_{m = 0 , … , M - 1} ( {Z}^{′} ( m ) ) ,$$

where M is the number of updated CSI report(s) according to Clause 5.2.1.6, (Z(m), Z′(m)) corresponds to the m-th updated CSI report and is defined as: (Z₁, Z₁′) of the Table 1.5.4-1 if max{μ_{PDCCH}, μ_{CSI-RS}, μ_{UL}}≤3 and if the CSI is triggered without a PUSCH with either transport block or HARQ-ACK or both when I=0 CPUs are occupied (according to Clause 5.2.1.6) and the CSI to be transmitted is a single CSI and corresponds to wideband frequency-granularity where the CSI corresponds to at most 4 CSI-RS ports in a single resource without CRI report and where CodebookType is set to ‘typeI-SinglePanel’ or where reportQuantity is set to ‘cri-RI-CQI’; or (Z₁, Z₁′) of the Table 1.5.4-2 if the CSI to be transmitted corresponds to wideband frequency-granularity where the CSI corresponds to at most 4 CSI-RS ports in a single resource without CRI report and where CodebookType is set to ‘typeI-SinglePanel’ or where reportQuantity is set to ‘cri-RI-CQI’; or (Z₁, Z₁′) of the Table 1.5.4-2 if the CSI to be transmitted corresponds to wideband frequency-granularity where the reportQuantity is set to ‘ssb-Index-SINR’, ‘cri-SINR’, ‘ssb-Index-SINR-Index’, or ‘cri-SINR-Index’, or (Z₃, Z₃′) of the Table 1.5.4-2 if reportQuantity is set to ‘cri-RSRP’, ‘ssb-Index-RSRP’, ‘cri-RSRP-Index’ or ‘ssb-Index-RSRP-Index’, where Xμ is according to UE 102 reported capability beamReportTiming and KBₗ is according to UE 102 reported capability beamSwitchTiming as defined in [13, TS 38.306], or (Z₂, Z₂′) of Table 1.5.4-2 otherwise. Additionally, μ of Table 1.5.4-1 and Table 1.5.4-2 corresponds to the min (μ_{PDCCH}, μ_{CSI-RS}, μ_{UL}) where the μ_{PDCCH} corresponds to the subcarrier spacing of the PDCCH with which the DCI was transmitted and μ_{UL} corresponds to the subcarrier spacing of the PUSCH with which the CSI report is to be transmitted and μ_{CSI-RS} corresponds to the minimum subcarrier spacing of the aperiodic CSI-RS triggered by the DCI.

TABLE 1.5.4-1
CSI computation delay requirement 1

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 1.5.4-2
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X₅ + KB3) | X₅ |
| 6 | 776 | 680 | 1216 | 1120 | min(776, X₆ + KB4) | X₆ |

### 2. Network, System, and Device Configurations and Arrangements

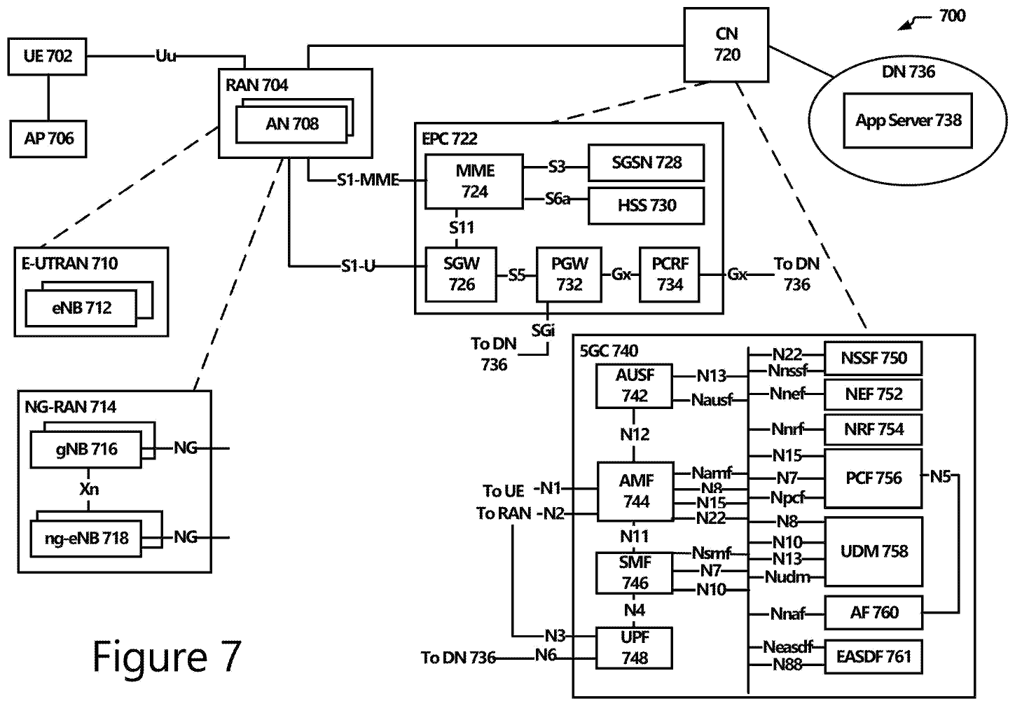

FIG. 7 depicts an example network architecture 700. The network 700 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 700 includes a UE 702, which is any mobile or non-mobile computing device designed to communicate with a RAN 704 via an over-the-air connection. The UE 702 is communicatively coupled with the RAN 704 by a Uu interface, which may be applicable to both LTE and NR systems. Examples of the UE 702 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. The UE 702 may be the same or similar to any of the other UEs discussed herein such as, for example, UE 102, UE 802, hardware resources 900, and/or any other UE discussed herein.

The network 700 may include a set of UEs 702 coupled directly with one another via a device-to-device (D2D), proximity services (ProSe), PC5, and/or sidelink (SL) interface, and/or any other suitable interface such as any of those discussed herein. These UEs 702 may be M2M, D2D, MTC, and/or IoT devices, and/or V2X systems that communicate using physical sidelink channels such as, but not limited to, PSBCH, PSDCH, PSSCH, PSCCH, PSFCH, and the like. The UE 702 may perform blind decoding attempts of SL channels/links according to the various examples herein.

In some examples, the UE 702 may additionally communicate with an AP 706 via an over-the-air (OTA) connection. The AP 706 manages a WLAN connection, which may serve to offload some/all network traffic from the RAN 704. The connection between the UE 702 and the AP 706 may be consistent with any IEEE 802.11 protocol. Additionally, the UE 702, RAN 704, and AP 706 may utilize cellular-WLAN aggregation/integration (e.g., LWA/LWIP). Cellular-WLAN aggregation may involve the UE 702 being configured by the RAN 704 to utilize both cellular radio resources and WLAN resources.

The RAN 704 includes one or more access network nodes (ANs) 708. The ANs 708 terminate air-interface(s) for the UE 702 by providing access stratum protocols including RRC, PDCP, RLC, MAC, and PHY/L1 protocols. In this manner, the AN 708 enables data/voice connectivity between CN 720 and the UE 702. The ANs 708 may be a macrocell base station or a low power base station for providing femtocells, picocells or other like cells having smaller coverage areas, smaller user capacity, or higher bandwidth compared to macrocells; or some combination thereof. In these implementations, an AN 708 be referred to as a BS, gNB, RAN node, eNB, ng-eNB, NodeB, RSU, TRP (or TRxP), and the like.

One example implementation is a “CU/DU split” architecture where the ANs 708 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 708 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of ANs 708 are coupled with one another via respective X2 interfaces if the RAN 704 is an LTE RAN or Evolved Universal Terrestrial Radio Access Network (E-UTRAN) 710, or respective Xn interfaces if the RAN 704 is a NG-RAN 714. The X2/Xn interfaces, which may be separated into control/user plane interfaces in some examples, may allow the ANs to communicate information related to handovers, data/context transfers, mobility, load management, interference coordination, and the like.

The ANs of the RAN 704 may each manage one or more cells, cell groups, component carriers, and the like to provide the UE 702 with an air interface for network access. The UE 702 may be simultaneously connected with a set of cells provided by the same or different ANs 708 of the RAN 704. For example, the UE 702 and RAN 704 may use carrier aggregation to allow the UE 702 to connect with a set of component carriers, each corresponding to a Pcell or Scell. In dual connectivity scenarios, a first AN 708 may be a master node that provides an MCG and a second AN 708 may be secondary node that provides an SCG. The first/second ANs 708 may be any combination of eNB, gNB, ng-eNB, and the like.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 702 provide radio information to one or more ANs 708 and/or one or more edge compute nodes (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 702 current location). As examples, the measurements collected by the UEs 702 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (E_{b}/N₀), energy per chip to interference power density ratio (E_{c}/I₀), energy per chip to noise power density ratio (E_{c}/N₀), peak-to-average power ratio (PAPR), reference signal received power (RSRP), reference signal received path power (RSRPP), reference signal received quality (RSRQ), Reference Signal Time Difference (RSTD), Real-Time Kinematic (RTK), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called accumulated delta range (ADR)), channel interference measurements, thermal noise power measurements, received interference power measurements, power histogram measurements, channel load measurements, STA statistics, relative time difference (RTD), Rx time delay, Rx timing error, Rx time delay, Rx timing error, ADR, time difference of arrival (TDOA), observed TDOA (OTDOA), relative TOA (RTOA), Angle-of-Arrival (AoA), Azimuth-AoA (A-AoA), Zenith-AoA (Z-AoA), Angle-of-Departure (AoD), Time-of-Arrival (ToF), and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022 Mar. 31) (“[TS36214]”), 3GPP TS 38.215 v17.3.0 (2023 Mar. 30) (“[TS38215]”), 3GPP TS 38.314 v17.2.0 (2023 Jan. 13) (“[TS38314]”), [TS37355], IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by one or more ANs 708 and provided to the edge compute node(s).

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to RRC (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 702, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (LIM); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v18.2.0 (2023 Mar. 30) (“[TS28552]”), 3GPP TS 32.425 v17.1.0 (2021 Jun. 24) (“[TS32425]”), and/or the like.

The radio information may be reported in response to a trigger event and/or on a periodic basis. Additionally or alternatively, individual UEs 702 report radio information either at a low periodicity or a high periodicity depending on a data transfer that is to take place, and/or other information about the data transfer. Additionally or alternatively, the edge compute node(s) may request the measurements from the ANs 708 at low or high periodicity, or the ANs 708 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 702 such as Key Performance Indicators (KPIs), with the measurement reports or separately from the measurement reports.

Additionally or alternatively, the RAN node 708 may also perform or collect various measurements, such as any of those discussed herein. Examples of measurements performed/collected by the RAN node 708 include: secondary synchronization signal (SSS) transmit power (e.g., the linear average over the power contributions (in [W]) of the resource elements that carry secondary synchronization signals within the secondary synchronization signal (SSS) bandwidth); UL Relative Time of Arrival (T_{UL-RTOA}) (e.g., T₀+t_{SRS}, where T₀ is the nominal beginning time of SFN 0 provided by SFN Initialization Time [15, TS 38.455], and t_{SRS}=(10n_{f}+n_{sf})×10⁻³, where n_{f} and n_{sf} are the system frame number and the subframe number of the SRS, respectively); gNB Rx-Tx time difference (e.g., defined as T_{gNB-RX}−T_{gNB-Tx}, where: T_{gNB-RX} is the TRP received timing of uplink subframe #i containing SRS associated with UE, defined by the first detected path in time. T_{gNB-TX} is the TRP transmit timing of downlink subframe #j that is closest in time to the subframe #i received from the UE); UL Angle of Arrival (UL AoA) (e.g., the estimated azimuth angle (A-AoA) and vertical angle (Z-AoA) of a UE 702 with respect to a reference direction); UL SRS reference signal received power (UL SRS-RSRP) (e.g., the linear average of the power contributions (in [W]) of the resource elements carrying sounding reference signals (SRS)); UL SRS reference signal received path power (UL SRS-RSRPP) (e.g., the power of the linear average of the channel response at the i-th path delay of the resource elements that carry the received UL SRS signal configured for the measurement, where UL SRS-RSRPP for 1st path delay is the power contribution corresponding to the first detected path in time); timing advance (“TA” or “T_{ADV}”) (e.g., the time difference T_{ADV}=(T_{gNB-RX}−T_{gNB-TX}), where: T_{gNB-RX} is the TRP received (Rx) timing of UL subframe #i containing PRACH transmitted from the UE 702, defined by the first detected path in time. The T_{gNB-TX} is the TRP transmit (Tx) timing of DL subframe #j that is closest in time to the subframe #i received from the UE 702. The detected PRACH is used to determine the start of one subframe containing that PRACH. The reference point for T_{gNB-RX} includes (see e.g., 3GPP TS 38.104): the Rx antenna connector for a type 1-C base station, the Rx antenna (i.e., the centre location of the radiating region of the Rx antenna) for a type 1-O or 2-O base station, and the Rx Transceiver Array Boundary connector for a type 1-H base station. The reference point for T_{gNB-TX} includes (see e.g., 3GPP TS 38.104): the Tx antenna connector for a type 1-C base station, the Tx antenna (i.e. the centre location of the radiating region of the Tx antenna) for a type 1-O or 2-O base station, the Tx Transceiver Array Boundary connector for a type 1-H base station); and/or UE-gNB RTT: (e.g., the sum of the UE's TA value(s) (see e.g., [TS38211]§ 4.3.1) and kmac; in some examples, the UE-gNB RTT is used for non-terrestrial networks).

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

The UE 702 can also perform determine reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 702 can include those discussed in 3GPP TS 38.211 v17.4.0 (2023 Jan. 4) (“[TS38211]”), 3GPP TS 38.212 v17.5.0 (2023 Mar. 30) (“[TS38212]”), 3GPP TS 38.213 v17.5.0 (2023 Mar. 30) (“[TS38213]”), 3GPP TS 38.214 v17.5.0 (2023-03-30) (“[TS38214]”), [TS38215], 3GPP TS 38.101-1 v18.1.0 (2023 Apr. 7) (“[TS38101-1]”), 3GPP TS 38.104 v18.1.0 (2023 Apr. 7) (“[TS38104]”), 3GPP TS 38.133 v18.1.0 (2023 Apr. 7) (“[TS38133]”), [TS38331], and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., MAMS [RFC8743]), IEEE/WiFi (e.g., [IEEE80211], [WiMAX], [IEEE16090], and the like), and/or any other like standards such as those discussed herein.

In V2X scenarios the UE 702 or AN 708 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network. Furthermore, one or more V2X RATs may be employed, which allow V2X nodes to communicate directly with one another, with infrastructure equipment (e.g., AN 708), and/or other devices/nodes. In some implementations, at least two distinct V2X RATs may be used including WLAN V2X (W-V2X) RATs based on IEEE V2X technologies (e.g., DSRC for the U.S. and ITS-G5 for Europe) and cellular V2X (C-V2X) RATs based on 3GPP V2X technologies (e.g., LTE V2X, 5G/NR V2X, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE STANDARDS ASSOCIATION, IEEE 1609.0-2019 (10 Apr. 2019) (“[IEEE16090]”), V2X Communications Message Set Dictionary, SAE INT'L (23 Jul. 2020) (“[J2735_202007]”), Intelligent Transport Systems in the 5 GHz frequency band (ITS-G5), (which is the L1 and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHZ frequency band that is generally used in the United States, while “ITS-G5” refers to vehicular communications in the 5.9 GHz frequency band in Europe. Since any number of different RATs are applicable that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020 January) (hereinafter “[EN302663]”) and describes the access layer of the ITS-S reference architecture. The ITS-G5 access layer comprises [IEEE80211], as well as features for Decentralized Congestion Control (DCC) methods discussed in ETSI TS 102 687 V1.2.1 (2018 April) (“[TS102687]”). The access layer for 3GPP LTE-V2X based interface(s) is outlined in, inter alia, ETSI EN 303 613 V1.1.1 (2020 January), 3GPP TS 23.285 v16.2.0 (2019 December); and 3GPP 5G/NR-V2X is outlined in, inter alia, 3GPP TR 23.786 v16.1.0 (2019 June) and 3GPP TS 23.287 v18.0.0 (2023 Mar. 31) (“[TS23287]”).

In examples where the RAN 704 is an E-UTRAN 710 with one or more eNBs 712, the E-UTRAN 710 provides an LTE air interface (Uu) with the parameters and characteristics at least as discussed in 3GPP TS 36.300 v17.2.0 (2022 Sep. 30) (“[TS36300]”). In examples where the RAN 704 is a next generation (NG)-RAN 714 with a set of gNBs 716, each gNB 716 connects with 5G-enabled UEs 702 using a 5G-NR air interface (which may also be referred to as a Uu interface) with parameters and characteristics as discussed in [TS38300], among many other 3GPP standards. Where the NG-RAN 714 includes a set of ng-eNBs 718, the one or more ng-eNBs 718 connect with a UE 702 via the 5G Uu and/or LTE Uu interface. The gNBs 716 and the ng-eNBs 718 connect with the 5GC 740 through respective NG interfaces, which include an N2 interface, an N3 interface, and/or other interfaces. The gNB 716 and the ng-eNB 718 are connected with each other over an Xn interface. Additionally, individual gNBs 716 are connected to one another via respective Xn interfaces, and individual ng-eNBs 718 are connected to one another via respective Xn interfaces. In some examples, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface). In some examples, individual gNBs 716 and/or individual ng-eNBs 718 may serve several TRPs (e.g., remote units, remote radio heads, UL-SRS only RPs, DL-PRS-only TPs, and/or the like).

The NG-RAN 714 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (e.g., PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

In some implementations, individual gNBs 716 can include a gNB-CU and a set of gNB-DUs. Additionally or alternatively, gNBs 716 can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 718 can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re) activation to the node having control plane connection towards the core network (e.g., over E1, X2, or the like). The node hosting the RLC protocol layer (e.g., gNB-DU) may perform user inactivity monitoring and further inform its inactivity or (re) activation to the node hosting the control plane (e.g., gNB-CU or gNB-CU-CP).

In these implementations, the NG-RAN 714, is layered into a Radio Network Layer (RNL) and a Transport Network Layer (TNL). The NG-RAN 714 architecture (e.g., the NG-RAN logical nodes and interfaces between them) is part of the RNL. For each NG-RAN interface (e.g., NG, Xn, F1, and the like) the related TNL protocol and the functionality are specified. The TNL provides services for user plane transport and/or signalling transport. In NG-Flex configurations, each NG-RAN node is connected to all AMFs 744 of AMF sets within an AMF region supporting at least one slice also supported by the NG-RAN node. The AMF Set and the AMF Region are defined in [TS23501].

The RAN 704 is communicatively coupled to CN 720 that includes network elements and/or network functions (NFs) to provide various functions to support data and telecommunications services to customers/subscribers (e.g., UE 702). The components of the CN 720 may be implemented in one physical node or separate physical nodes. In some examples, NFV may be utilized to virtualize any or all of the functions provided by the network elements of the CN 720 onto physical compute/storage resources in servers, switches, and the like. A logical instantiation of the CN 720 may be referred to as a network slice, and a logical instantiation of a portion of the CN 720 may be referred to as a network sub-slice.

The CN 720 may be an LTE CN 722 (also referred to as an Evolved Packet Core (EPC) 722). The EPC 722 may include MME 724, SGW 726, SGSN 728, HSS 730, PGW 732, and PCRF 734 coupled with one another over interfaces (or “reference points”) as shown. The NFs in the EPC 722 are briefly introduced as follows. The MME 724 implements mobility management functions to track a current location of the UE 702 to facilitate paging, bearer activation/deactivation, handovers, gateway selection, authentication, and the like. The SGW 726 terminates an S1 interface toward the RAN 710 and routes data packets between the RAN 710 and the EPC 722. The SGW 726 may be a local mobility anchor point for inter-RAN node handovers and also may provide an anchor for inter-3GPP mobility. Other responsibilities may include lawful intercept, charging, and some policy enforcement. The SGSN 728 tracks a location of the UE 702 and performs security functions and access control. The SGSN 728 also performs inter-EPC node signaling for mobility between different RAT networks; PDN and S-GW selection as specified by MME 724; MME 724 selection for handovers; and the like. The S3 reference point between the MME 724 and the SGSN 728 enable user and bearer information exchange for inter-3GPP access network mobility in idle/active states. The HSS 730 includes a database for network users, including subscription-related information to support the network entities' handling of communication sessions. The HSS 730 can provide support for routing/roaming, authentication, authorization, naming/addressing resolution, location dependencies, and the like. An S6a reference point between the HSS 730 and the MME 724 may enable transfer of subscription and authentication data for authenticating/authorizing user access to the EPC 720. The PGW 732 may terminate an SGi interface toward a data network (DN) 736 that may include an application (app)/content server 738. The PGW 732 routes data packets between the EPC 722 and the data network 736. The PGW 732 is communicatively coupled with the SGW 726 by an S5 reference point to facilitate user plane tunneling and tunnel management. The PGW 732 may further include a node for policy enforcement and charging data collection (e.g., PCEF). Additionally, the SGi reference point may communicatively couple the PGW 732 with the same or different data network 736. The PGW 732 may be communicatively coupled with a PCRF 734 via a Gx reference point. The PCRF 734 is the policy and charging control element of the EPC 722. The PCRF 734 is communicatively coupled to the app/content server 738 to determine appropriate QoS and charging parameters for service flows. The PCRF 732 also provisions associated rules into a PCEF (via Gx reference point) with appropriate TFT and QCI.

The CN 720 may be a 5GC 740 including an Authentication Server Function (AUSF) 742, Access and Mobility Management Function (AMF) 744, Session Management Function (SMF) 746, User Plane Function (UPF) 748, Network Slice Selection Function (NSSF) 750, Network Exposure Function (NEF) 752, Network Repository Function (NRF) 754, Policy Control Function (PCF) 756, Unified Data Management (UDM) 758, Unified Data Repository (UDR) 759, and Application Function (AF) 760 coupled with one another over various interfaces as shown. The NFs in the 5GC 740 are briefly introduced as follows.

The AUSF 742 stores data for authentication of UE 702 and handle authentication-related functionality. The AUSF 742 may facilitate a common authentication framework for various access types.

The AMF 744 allows other functions of the 5GC 740 to communicate with the UE 702 and the RAN 704 and to subscribe to notifications about mobility events with respect to the UE 702. The AMF 744 is also responsible for registration management (e.g., for registering UE 702), connection management, reachability management, mobility management, lawful interception of AMF-related events, and access authentication and authorization. The AMF 744 provides transport for SM messages between the UE 702 and the SMF 746, and acts as a transparent proxy for routing SM messages. AMF 744 also provides transport for SMS messages between UE 702 and an SMSF. AMF 744 interacts with the AUSF 742 and the UE 702 to perform various security anchor and context management functions. Furthermore, AMF 744 is a termination point of a RAN-CP interface, which includes the N2 reference point between the RAN 704 and the AMF 744. The AMF 744 is also a termination point of NAS (N1) signaling, and performs NAS ciphering and integrity protection.

AMF 744 also supports NAS signaling with the UE 702 over an N3IWF interface. The N3IWF provides access to untrusted entities. N3IWF may be a termination point for the N2 interface between the (R)AN 704 and the AMF 744 for the control plane, and may be a termination point for the N3 reference point between the (R)AN 714 and the 748 for the user plane. As such, the AMF 744 handles N2 signaling from the SMF 746 and the AMF 744 for PDU sessions and QoS, encapsulate/de-encapsulate packets for IPSec and N3 tunneling, marks N3 user-plane packets in the uplink, and enforces QoS corresponding to N3 packet marking taking into account QoS requirements associated with such marking received over N2. N3IWF may also relay UL and DL control-plane NAS signaling between the UE 702 and AMF 744 via an N1 reference point between the UE 702 and the AMF 744, and relay uplink and downlink user-plane packets between the UE 702 and UPF 748. The N3IWF also provides mechanisms for IPsec tunnel establishment with the UE 702. The AMF 744 may exhibit an Namf service-based interface, and may be a termination point for an N14 reference point between two AMFs 744 and an N17 reference point between the AMF 744 and a 5G-EIR (not shown by FIG. 7).

The SMF 746 is responsible for SM (e.g., session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 744 over N2 to AN 708; and determining SSC mode of a session. SM refers to management of a PDU session, and a PDU session or “session” refers to a PDU connectivity service that provides or enables the exchange of PDUs between the UE 702 and the DN 736. The SMF 746 may also include the following functionalities to support edge computing enhancements (see e.g., [TS23548]): selection of EASDF 761 and provision of its address to the UE as the DNS server for the PDU session; usage of EASDF 761 services as defined in [TS23548]; and for supporting the application layer architecture defined in [TS23558], provision and updates of ECS address configuration information to the UE. Discovery and selection procedures for EASDFs 761 is discussed in [TS23501]§ 6.3.23.

The UPF 748 acts as an anchor point for intra-RAT and inter-RAT mobility, an external PDU session point of interconnect to data network 736, and a branching point to support multi-homed PDU session. The UPF 748 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 748 may include an uplink classifier to support routing traffic flows to a data network.

The NSSF 750 selects a set of network slice instances serving the UE 702. The NSSF 750 also determines allowed NSSAI and the mapping to the subscribed S-NSSAIs, if needed. The NSSF 750 also determines an AMF set to be used to serve the UE 702, or a list of candidate AMFs 744 based on a suitable configuration and possibly by querying the NRF 754. The selection of a set of network slice instances for the UE 702 may be triggered by the AMF 744 with which the UE 702 is registered by interacting with the NSSF 750; this may lead to a change of AMF 744. The NSSF 750 interacts with the AMF 744 via an N22 reference point; and may communicate with another NSSF in a visited network via an N31 reference point (not shown).

The NEF 752 securely exposes services and capabilities provided by 3GPP NFs for third party, internal exposure/re-exposure, AFs 760, edge computing or fog computing systems (e.g., edge compute node, and the like. In such examples, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics.

The NRF 754 supports service discovery functions, receives NF discovery requests from NF instances, and provides information of the discovered NF instances to the requesting NF instances. NRF 754 also maintains information of available NF instances and their supported services. The NRF 754 also supports service discovery functions, wherein the NRF 754 receives NF Discovery Request from NF instance or an SCP (not shown), and provides information of the discovered NF instances to the NF instance or SCP.

The PCF 756 provides policy rules to control plane functions to enforce them, and may also support unified policy framework to govern network behavior. The PCF 756 may also implement a front end to access subscription information relevant for policy decisions in a UDR 759 of the UDM 758. In addition to communicating with functions over reference points as shown, the PCF 756 exhibit an Npcf service-based interface.

The UDM 758 handles subscription-related information to support the network entities' handling of communication sessions, and stores subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR to allow the UDM 758, PCF 756, and NEF 752 to access a particular set of the stored data, as well as to read, update (e.g., add, modify), delete, and subscribe to notification of relevant data changes in the UDR. The UDM 758 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

Edge Application Server Discovery Function (EASDF) 761 exhibits an Neasdf service-based interface, and is connected to the SMF 746 via an N88 interface. One or multiple EASDF instances may be deployed within a PLMN, and interactions between 5GC NF(s) and the EASDF 761 take place within a PLMN. The EASDF 761 includes one or more of the following functionalities: registering to NRF 754 for EASDF 761 discovery and selection; handling the DNS messages according to the instruction from the SMF 746; and/or terminating DNS security, if used. Handling the DNS messages according to the instruction from the SMF 746 includes one or more of the following functionalities: receiving DNS message handling rules and/or BaselineDNSPattern from the SMF 746; exchanging DNS messages from/with the UE 702; forwarding DNS messages to C-DNS or L-DNS for DNS query; adding EDNS client subnet (ECS) option into DNS query for an FQDN; reporting to the SMF 746 the information related to the received DNS messages; and/or buffering/discarding DNS messages from the UE 702 or DNS Server. The EASDF has direct user plane connectivity (e.g., without any NAT) with the PSA UPF over N6 for the transmission of DNS signalling exchanged with the UE. The deployment of a NAT between EASDF 761 and PSA UPF 748 may or may not be supported. Additional aspects of the EASDF 761 are discussed in [TS23548].

AF 760 provides application influence on traffic routing, provide access to NEF 752, and interact with the policy framework for policy control. The AF 760 may influence UPF 748 (re) selection and traffic routing. Based on operator deployment, when AF 760 is considered to be a trusted entity, the network operator may permit AF 760 to interact directly with relevant NFs. In some implementations, the AF 760 is used for edge computing implementations.

The 5GC 740 may enable edge computing by selecting operator/3rd party services to be geographically close to a point that the UE 702 is attached to the network. This may reduce latency and load on the network. In edge computing implementations, the 5GC 740 may select a UPF 748 close to the UE 702 and execute traffic steering from the UPF 748 to DN 736 via the N6 interface. This may be based on the UE subscription data, UE location, and information provided by the AF 760, which allows the AF 760 to influence UPF (re) selection and traffic routing.

The data network (DN) 736 may represent various network operator services, Internet access, or third party services that may be provided by one or more servers including, for example, application (app)/content server 738. The DN 736 may be an operator external public, a private PDN, or an intra-operator packet data network, for example, for provision of IMS services. In this example, the app server 738 can be coupled to an IMS via an S-CSCF or the I-CSCF. In some implementations, the DN 736 may represent one or more local area DNs (LADNs), which are DNs 736 (or DN names (DNNs)) that is/are accessible by a UE 702 in one or more specific areas. Outside of these specific areas, the UE 702 is not able to access the LADN/DN 736.

Additionally or alternatively, the DN 736 may be an edge DN 736, which is a (local) DN that supports the architecture for enabling edge applications. In these examples, the app server 738 may represent the physical hardware systems/devices providing app server functionality and/or the application software resident in the cloud or at an edge compute node that performs server function(s). In some examples, the app/content server 738 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 710, 714. For example, the edge compute nodes can provide a connection between the RAN 714 and UPF 748 in the 5GC 740. The edge compute nodes can use one or more NFV instances instantiated on virtualization infrastructure within the edge compute nodes to process wireless connections to and from the RAN 714 and UPF 748.

In some implementations, the edge compute nodes provide a distributed computing environment for application and service hosting, and also provide storage and processing resources so that data and/or content can be processed in close proximity to subscribers (e.g., users of UEs 702) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 702, CN 720, DN 736, and/or server(s) 738, or vice versa. For example, a device application or client application operating in a UE 702 may offload application tasks or workloads to one or more edge compute nodes. In another example, an edge compute node may offload application tasks or workloads to a set of UEs 702 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 702. The VI of the edge compute nodes provide virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), ETSI GR MEC 031 v2.1.1 (2020 October), U.S. Provisional App. No. 63/003,834 filed Apr. 1, 2020 (“[US′834]”), and Int'l App. No. PCT/US2020/066969 filed on Dec. 23, 2020 (“[PCT′696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1 (2015 January), ETSI GS NFV-INF 003 V1.1.1 (2014 December), ETSI GS NFV-INF 004 V1.1.1 (2015 January), ETSI GS NFV-MAN 001 v1.1.1 (2014 December), and/or Israel et al., OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021 Dec. 23) (“[TS28533]”), the contents of each of which are hereby incorporated by reference in their entireties.

In another example implementation, the ECT is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI/ML. Various aspects of the O-RAN architecture are described in O-RAN Working Group 1 (Use Cases and Overall Architecture): O-RAN Architecture Description, O-RAN ALLIANCE WG1, O-RAN Architecture Description v08.00, Release R003 (March 2023); O-RAN Operations and Maintenance Architecture Specification v04.00, O-RAN ALLIANCE WG1 (February 2021); O-RAN Working Group 2 AI/ML workflow description and requirements v01.03 O-RAN ALLIANCE WG2 (October 2021); O-RAN Working Group 2 (Non-RT RIC and A1 interface WG): R1 interface: General Aspects and Principles 4.0, v04.00, Release R003 (March 2023); O-RAN Working Group 2 (Non-RT RIC and A1 interface WG) Non-RT RIC Architecture v02.01 (October 2022); O-RAN Working Group 3 (Near-Real-time RAN Intelligent Controller and E2 Interface Working Group): Near-RT RIC Architecture, v04.00, Release R003 (March 2023); O-RAN Working Group 4 (Open Fronthaul Interfaces WG) Control, User and Synchronization Plane Specification, v11.00, Release R003 (March 2023); O-RAN Fronthaul Working Group 4 Cooperative Transport Interface Transport Control Plane Specification, v03.00 (October 2022); O-RAN Fronthaul Working Group 4 Cooperative Transport Interface Transport Management Plane Specification, v11.00, Release R003 (March 2023); O-RAN Open X-haul Transport Working Group Management interfaces for Transport Network Elements, v05.00, Release R003 (March 2023); O-RAN Open Transport Working Group 9 Xhaul Packet Switched Architectures and Solutions, v03.00, Release R003 (March 2023); O-RAN Open X-haul Transport Working Group Synchronization Architecture and Solution Specification, v03.00 (October 2022); O-RAN Open Xhaul Transport WG9 WDM-based Fronthaul Transport, v03.00, Release R003 (March 2023); O-RAN Operations and Maintenance Architecture, v08.00, Release R003 (March 2023) (“[ORAN.OAM-Arch]”); O-RAN Operations and Maintenance Interface Specification, v09.00, Release R003 (March 2023); (collectively referred to as “[O-RAN]”), the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v18.1.0 (2022 Dec. 23) (“[TS23558]”), 3GPP TS 23.501 v18.0.0 (2022-12-21) (“[TS23501]”), 3GPP TS 23.502 v18.1.1 (2023 Apr. 5) (“[TS23502]”), 3GPP TS 23.548 v18.1.0 (2023 Apr. 6) (“[TS23548]”), 3GPP TS 28.538 v18.2.0 (2023 Mar. 30) (“[TS28538]”), 3GPP TR 23.700-98 v18.0.0 (2022 Dec. 23) (“[TR23700-98]”), 3GPP TS 23.222 v18.0.0 (2022 Dec. 23) (“[TS23222]”), 3GPP TS 33.122 v18.0.0 (2022 Dec. 16) (“[TS33122]”), 3GPP TS 29.222 v17.1.0 (2021 Jun. 25) (“[TS29222]”), 3GPP TS 29.522 v18.0.0 (2022 Dec. 16) (“[TS29522]”), 3GPP TS 29.122 v18.0.0 (2022 Dec. 16) (“[TS29122]”), 3GPP TS 23.682 v17.3.0 (2022 Jun. 15) (“[TS23682]”), 3GPP TS 23.434 v18.3.0 (2022 Dec. 23) (“[TS23434]”), and 3GPP TS 23.401 v18.0.0 (2022 Dec. 21) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

The interfaces of the 5GC 740 include reference points and service-based interfaces. The reference points include: N1 (between the UE 702 and the AMF 744), N2 (between RAN 714 and AMF 744), N3 (between RAN 714 and UPF 748), N4 (between the SMF 746 and UPF 748), N5 (between PCF 756 and AF 760), N6 (between UPF 748 and DN 736), N7 (between SMF 746 and PCF 756), N8 (between UDM 758 and AMF 744), N9 (between two UPFs 748), N10 (between the UDM 758 and the SMF 746), N11 (between the AMF 744 and the SMF 746), N12 (between AUSF 742 and AMF 744), N13 (between AUSF 742 and UDM 758), N14 (between two AMFs 744; not shown), N15 (between PCF 756 and AMF 744 in case of a non-roaming scenario, or between the PCF 756 in a visited network and AMF 744 in case of a roaming scenario), N16 (between two SMFs 746; not shown), and N22 (between AMF 744 and NSSF 750). Other reference point representations not shown in FIG. 7 can also be used. The service-based representation of FIG. 7 represents NFs within the control plane that enable other authorized NFs to access their services. The service-based interfaces (SBIs) include: Namf (SBI exhibited by AMF 744), Nsmf (SBI exhibited by SMF 746), Nnef (SBI exhibited by NEF 752), Npcf (SBI exhibited by PCF 756), Nudm (SBI exhibited by the UDM 758), Naf (SBI exhibited by AF 760), Nnrf (SBI exhibited by NRF 754), Nnssf (SBI exhibited by NSSF 750), Nausf (SBI exhibited by AUSF 742). Other service-based interfaces (e.g., Nudr, N5g-eir, and Nudsf) not shown in FIG. 7 can also be used. In some examples, the NEF 752 can provide an interface to edge compute nodes 736x, which can be used to process wireless connections with the RAN 714.

Although not shown by FIG. 7, the system 700 may also include NFs that are not shown such as, for example, Unstructured Data Storage Function (UDSF), Network Slice Admission Control Function (NSACF), Network Slice-specific and SNPN Authentication and Authorization Function (NSSAAF), UE radio Capability Management Function (UCMF), 5G-Equipment Identity Register (5G-EIR), Network Data Analytics Function (NWDAF), CHarging Function (CHF), Time Sensitive Networking AF (TSN AF), Time Sensitive Communication and Time Synchronization Function (TSCTSF), Data Collection Coordination Function (DCCF), Analytics Data Repository Function (ADRF), Messaging Framework Adaptor Function (MFAF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

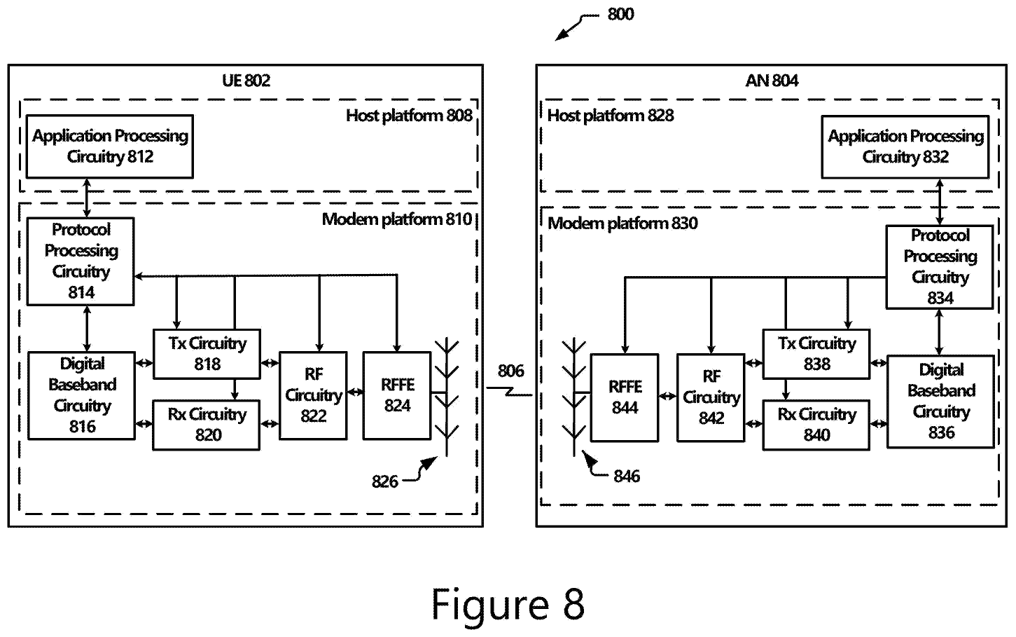

FIG. 8 schematically illustrates a wireless network 800. The wireless network 800 includes a UE 802 in wireless communication with an AN 804. The UE 802 may be the same or similar to, and substantially interchangeable with any of the of the UEs discussed herein such as, for example, UE 102, UE 702, hardware resources 900, and/or any other UE discussed herein. The AN 804 may be the same or similar to, and substantially interchangeable with any of the of the ANs (network access nodes (NANs)) discussed herein such as, for example, TRPs 108, AP 706, ANs 708, RAN 704, hardware resources 900, and/or any other AN/NAN discussed herein.

The UE 802 may be communicatively coupled with the AN 804 via connection 806. The connection YY06 is illustrated as an air interface to enable communicative coupling, and can be consistent with cellular communications protocols such as an LTE protocol or a 5G NR protocol operating at mm Wave or sub-6 GHZ frequencies.

The UE 802 includes a host platform 808 coupled with a modem platform 810. The host platform 808 includes application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations includes transport (for example UDP) and Internet (e.g., IP) operations

The protocol processing circuitry 814 may implement one or more of layer operations to facilitate transmission or reception of data over the connection 806. The layer operations implemented by the protocol processing circuitry 814 includes, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations includes, for PHY operations including one or more of HARQ-ACK functions, example, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which includes or connect to one or more antenna panels 826. Briefly, the transmit circuitry 818 includes a digital-to-analog converter, mixer, intermediate frequency (IF) components, etc.; the receive circuitry 820 includes an analog-to-digital converter, mixer, IF components, etc.; the RF circuitry 822 includes a low-noise amplifier, a power amplifier, power tracking components, etc.; RFFE 824 includes filters (e.g., surface/bulk acoustic wave filters), switches, antenna tuners, beamforming components (e.g., phase-array antenna components), etc. The selection and arrangement of the components of the transmit circuitry 818, receive circuitry 820, RF circuitry 822, RFFE 824, and antenna panels 826 (referred generically as “transmit/receive components” or “Tx/Rx components”) may be specific to details of a specific implementation such as, for example, whether communication is TDM or FDM, in mmWave or sub-6 gHz frequencies, etc. In some examples, the transmit/receive components may be arranged in multiple parallel transmit/receive chains, may be disposed in the same or different chips/modules, etc.

In some examples, the protocol processing circuitry 814 includes one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some examples, the antenna panels 826 may receive a transmission from the AN 804 by receive-beamforming signals received by a set of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some examples, the transmit components of the UE 804 may apply a spatial filter to the data to be transmitted to form a transmit beam emitted by the antenna elements of the antenna panels 826.

Similar to the UE 802, the AN 804 includes a host platform 828 coupled with a modem platform 830. The host platform 828 includes application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

Examples of the antenna elements of the antenna panels 826 and/or the antenna elements of the antenna panels 846 include planar inverted-F antennas (PIFAs), monopole antennas, dipole antennas, loop antennas, patch antennas, Yagi antennas, parabolic dish antennas, omni-directional antennas, and/or the like.

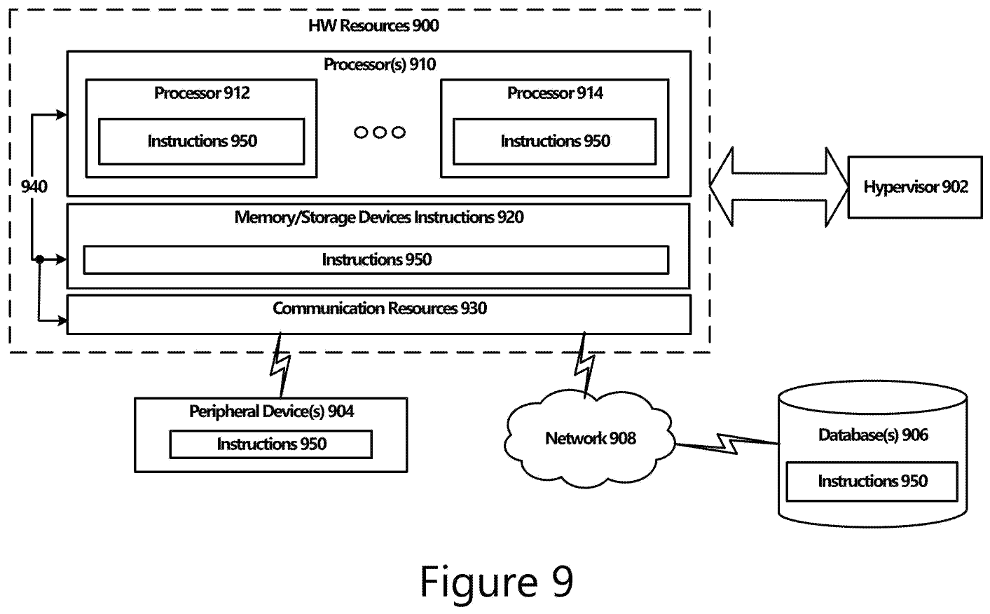

FIG. 9 illustrates components capable of reading instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For examples where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

### 3. Example Implementations

Additional examples of the presently described methods, devices, systems, and networks discussed herein include the following, non-limiting example implementations. Each of the following non-limiting examples may stand on its own or may be combined in any permutation or combination with any one or more of the other examples provided below or throughout the present disclosure.

Example 1 includes a method of Timing Advance (TA) association for single-TRP and multi-TRP operation, where two TAs are associated with two TRP-IDs.

Example 2 includes a method of CSI prediction, where the precoder prediction can be done at the UE side or the gNB side.

Example 3 includes a method of CSI measurement, where the CSI-RS sampling periodicity and maximum Doppler frequency meets Nyquist criterion, Δt≤1/(2·fₘₐₓ).

Example 4 includes a method of codebook design, where a new codebook is designed based on spatial, frequency, and time dimensions.

Example 5 includes a method comprising: performing the method of any one or more of examples 1-4, and/or some other example(s) herein.

Example 6 includes a method of operating a UE, the method comprising: receiving timing advance information for a serving cell, wherein the timing advance information includes respective timing advances for a plurality of TRPs associated with the serving cell; and transmitting one or more uplink signals based on the timing advance information.

Example 7 includes the method of example 6 and/or some other example(s) herein, wherein the timing advances are associated with respective TRP IDs of the plurality of TRPs.

Example 8 includes the method of example 6-7 and/or some other example(s) herein, wherein the transmitting one or more uplink signals includes transmitting a simultaneous multi-TRP transmission to two or more of the TRPs.

Example 9 includes a method comprising: performing the method of any one or more of examples 1-8 and/or some other example(s) herein.

Example Z01 includes one or more computer readable media comprising instructions, wherein execution of the instructions by processor circuitry is to cause the processor circuitry to perform the method of any one of examples 1-9.

Example Z02 includes a computer program comprising the instructions of example Z01.

Example Z03 includes an Application Programming Interface defining functions, methods, variables, data structures, and/or protocols for the computer program of example Z02.

Example Z04 includes an API or specification defining functions, methods, variables, data structures, protocols, and the like, defining or involving use of any of examples 1-9 or portions thereof, or otherwise related to any of examples 1-9 or portions thereof.

Example Z05 includes an apparatus comprising circuitry loaded with the instructions of example Z01.

Example Z06 includes an apparatus comprising circuitry operable to run the instructions of example Z01.

Example Z07 includes an integrated circuit comprising one or more of the processor circuitry of example Z01 and the one or more computer readable media of example Z01.

Example Z08 includes a computing system comprising the one or more computer readable media and the processor circuitry of example Z01.

Example Z09 includes an apparatus comprising means for executing the instructions of example Z01.

Example Z10 includes a signal generated as a result of executing the instructions of example Z01.

Example Z11 includes a data unit generated as a result of executing the instructions of example Z01.

Example Z12 includes the data unit of example Z10 and/or some other example(s) herein, wherein the data unit is a datagram, network packet, data frame, data segment, a Protocol Data Unit (PDU), a Service Data Unit (SDU), a message, or a database object.

Example Z13 includes a signal encoded with the data unit of examples Z11 and/or Z12.

Example Z14 includes an electromagnetic signal carrying the instructions of example Z01.

Example Z15 includes an apparatus comprising means for performing the method of any one of examples 1-9 and/or some other example(s) herein.

Example Z16 includes an edge compute node executing a service as part of one or more edge applications instantiated on virtualization infrastructure, the service being related to any of examples 1-9, portions thereof, and/or some other example(s) herein.

### 4. Terminology

For the purposes of the present document, the following terms and definitions are applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some examples, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems. The term “gateway” at least in some examples refers to a network appliance that allows data to flow from one network to another network, or a computing system or application configured to perform such tasks. Examples of gateways include IP gateways, Internet-to-Orbit (120) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface. The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, TRP, a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA. The term “primary cell” or “PCell” at least in some examples refers to a Master Cell Group (MCG) cell, operating on a primary frequency, in which a UE either performs an initial connection establishment procedure or initiates a connection re-establishment procedure. The term “Secondary Cell” or “SCell” at least in some examples refers to a cell providing additional radio resources on top of a special cell (SpCell) for a UE configured with CA. The term “special cell” or “SpCell” at least in some examples refers to a PCell for non-DC operation or refers to a PCell of an MCG or a PSCell of an SCG for DC operation. The term “Master Cell Group” or “MCG” at least in some examples refers to a group of serving cells associated with a “Master Node” comprising a SpCell (PCell) and optionally one or more SCells. The term “Secondary Cell Group” or “SCG” at least in some examples refers to a subset of serving cells comprising a Primary SCell (PSCell) and zero or more SCells for a UE configured with DC. The term “Primary SCG Cell” refers to the SCG cell in which a UE performs random access when performing a reconfiguration with sync procedure for DC operation. The term “handover” at least in some examples refers to the transfer of a user's connection from one radio channel to another (can be the same or different cell). Additionally or alternatively, the term “handover” at least in some examples refers to the process in which a radio access network changes the radio transmitters, radio access mode, and/or radio system used to provide the bearer services, while maintaining a defined bearer service QoS.

The term “Master Node” or “MN” at least in some examples refers to a NAN that provides control plane connection to a core network. The term “Secondary Node” or “SN” at least in some examples refers to a NAN providing resources to the UE in addition to the resources provided by an MN and/or a NAN with no control plane connection to a core network. The term “E-UTEAN NodeB”, “eNodeB”, or “eNB” at least in some examples refers to a RAN node providing E-UTRA user plane (e.g., PDCP, RLC, MAC, PHY) and control plane (e.g., RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. In some examples, two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022-04-15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an CU, DU, and/or RU are physically separated from one another. Additionally or alternatively, the term “split architecture” at least in some examples refers to a RAN architecture such as those discussed in 3GPP TS 38.401 v17.3.0 (2023 Jan. 6) and/or 3GPP TS 38.410 v 17.1.0 (2022-06-23), the contents of each of which are hereby incorporated by reference in their entireties. The term “integrated architecture at least in some examples refers to an architecture in which an RU and DU are implemented on one platform, and/or an architecture in which a DU and a CU are implemented on one platform.

The term “transmission reception point” or “TRP” at least in some examples refers to a set of geographically co-located antennas (e.g., antenna array with one or more antenna elements) supporting transmission point (TP) and/or reception point (RP) functionality. The term “transmission point” or “TP” at least in some examples refers to a set of geographically co-located transmit antennas (e.g., antenna array with one or more antenna elements) for an individual cell, part of an individual cell, or one DL-PRS-only TP. In some examples, a TP can include antennas of a base station (eNB, gNB, ng-eNB, and/or the like), remote radio heads, a remote antenna of a base station, an antenna of a PRS-only TP, and/or the like. In some examples, one cell can be formed by or otherwise include one or multiple TPs. In some examples, each TP may correspond to one cell for a homogeneous deployment. The term “PRS-only TP” at least in some examples refers to a TP that only transmits PRS or DL-PRS (positioning) signals (e.g., for PRS-based Terrestrial Beacon System (TBS)), and is not associated with a cell. The term “reception point” or “RP” at least in some examples refers to a set of geographically co-located reception antennas (e.g., antenna array with one or more antenna elements) for an individual cell, part of an individual cell, or an individual UL-SRS-only RP. In some examples, RPs can include base station (ng-eNB or gNB) antennas, remote radio heads, a remote antenna of a base station, an antenna of a UL-SRS-only RP, and/or the like. In some examples, one cell can include one or multiple RPs. In some examples, each RP may correspond to one cell for a homogeneous deployment. The term “SRS-only RP” at least in some examples refers to an RP that only receives UL-SRS signals and is not associated with a cell.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N₂ and N₃ reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “SMTC” refers to an SSB-based measurement timing configuration configured by SSB-Measurement TimingConfiguration. The term “SSB” refers to an SS/PBCH block.

The term “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation;

otherwise, the term “Special Cell” refers to the Pcell.

The term “edge computing” at least in some examples refers to an implementation or arrangement of distributed computing elements that move processing activities and resources (e.g., compute, storage, acceleration, and/or network resources) towards the “edge” of the network in an effort to reduce latency and increase throughput for endpoint users (client devices, user equipment, and the like). Additionally or alternatively, term “edge computing” at least in some examples refers to a set of services hosted relatively close to a client/UE's access point of attachment to a network to achieve relatively efficient service delivery through reduced end-to-end latency and/or load on the transport network. In some examples, edge computing implementations involve the offering of services and/or resources in a cloud-like systems, functions, applications, and subsystems, from one or multiple locations accessible via wireless networks. Additionally or alternatively, term “edge computing” at least in some examples refers to the concept, as described in [TS23501], that enables operator and 3rd party services to be hosted close to a UE's access point of attachment, to achieve an efficient service delivery through the reduced end-to-end latency and load on the transport network. The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network, however, references to an “edge computing system” generally refer to a distributed architecture, organization, or collection of multiple nodes and devices, and which is organized to accomplish or offer some aspect of services or resources in an edge computing setting. The term “edge computing platform” or “edge platform” at least in some examples refers to a collection of functionality that is used to instantiate, execute, or run edge applications on a specific edge compute node (e.g., virtualisation infrastructure and/or the like), enable such edge applications to provide and/or consume edge services, and/or otherwise provide one or more edge services. The term “edge application” or “edge app” at least in some examples refers to an application that can be instantiated on, or executed by, an edge compute node within an edge computing network, system, or framework, and can potentially provide and/or consume edge computing services. The term “edge service” at least in some examples refers to a service provided via an edge compute node and/or edge platform, either by the edge platform itself and/or by an edge application.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “network function” or “NF” at least in some examples refers to a functional block within a network infrastructure that has one or more external interfaces and a defined functional behavior. The term “network service” or “NS” at least in some examples refers to a composition or collection of NF(s) and/or network service(s), defined by its functional and behavioral specification(s). The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “management function” at least in some examples refers to a logical entity playing the roles of a service consumer and/or a service producer. The term “management service” at least in some examples refers to a set of offered management capabilities. The term “network function virtualization” or “NFV” at least in some examples refers to the principle of separating network functions from the hardware they run on by using virtualisation techniques and/or virtualization technologies. The term “virtualized network function” or “VNF” at least in some examples refers to an implementation of an NF that can be deployed on a Network Function Virtualisation Infrastructure (NFVI). The term “Network Functions Virtualisation Infrastructure Manager” or “NFVI” at least in some examples refers to a totality of all hardware and software components that build up the environment in which VNFs are deployed. The term “Virtualized Infrastructure Manager” or “VIM” at least in some examples refers to a functional block that is responsible for controlling and managing the NFVI compute, storage and network resources, usually within one operator's infrastructure domain. The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings. The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and includes identifying communication partners, determining resource availability, and synchronizing communication. Examples of application layer protocols include HTTP, HTTPS, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VOIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (uTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, theterm “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signalling Radio Bearers (SRBs) and Data Radio Bearers (DRBs); mobility functions/services; QoS management; and some sidelink specific services and functions over the Uu interface (see e.g., 3GPP TS 36.331 v17.4.0 (2023 Mar. 30) (“[TS36331]”) and/or 3GPP TS 38.331 v17.4.0 (2023 Mar. 30) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022 Apr. 13) (“[TS37324]”).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.2.0 (2023 Jan. 13) and/or 3GPP TS 38.323 v17.4.0 (2023 Mar. 28) (“[TS38323]”)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 36.322 v17.0.0 (2022 Apr. 15) and 3GPP TS 38.322 v17.2.0 (2023 Jan. 13) (“[TS38322]”)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., 3GPP TS 36.321 v17.3.0 (2023 Jan. 13), and 3GPP TS 38.321 v17.4.0 (2023 Mar. 29) (“[TS38321]”).

The term “physical layer”, “PHY layer”, or “PHY” at least in some examples refers to a protocol layer or sublayer that includes capabilities to transmit and receive modulated signals for communicating in a communications network (see e.g., 3GPP TS 36.201 v17.0.0 (2022 Mar. 31), and 3GPP TS 38.201 v17.0.0 (2022 Jan. 5) (“[TS38201]”)

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wireless access technologies/RATs, wireline, wireline-cable, wireline broadband forum (wireline-BBF), Ethernet (see e.g., IEEE Standard for Ethernet, IEEE Std 802.3-2018 (31 Aug. 2018) (“[IEEE8023]”)) and variants thereof, fiber optics networks (e.g., ITU-T G.651, ITU-T G.652, Optical Transport Network (OTN), Synchronous optical networking (SONET) and synchronous digital hierarchy (SDH), and the like), digital subscriber line (DSL) and variants thereof, Data Over Cable Service Interface Specification (DOCSIS) technologies, hybrid fiber-coaxial (HFC) technologies, and/or the like. Examples of RATs (or RAT types) and/or communications protocols include Advanced Mobile Phone System (AMPS) technologies (e.g., Digital AMPS (D-AMPS), Total Access Communication System (TACS) and variants thereof, such as Extended TACS (ETACS), and the like); Global System for Mobile Communications (GSM) technologies (e.g., Circuit Switched Data (CSD), High-Speed CSD (HSCSD), General Packet Radio Service (GPRS), and Enhanced Data Rates for GSM Evolution (EDGE)); Third Generation Partnership Project (3GPP) technologies (e.g., Universal Mobile Telecommunications System (UMTS) and variants thereof (e.g., UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) and variants thereof (e.g., HSPA Plus (HSPA+)), Long Term Evolution (LTE) and variants thereof (e.g., LTE-Advanced (LTE-A), Evolved UTRA (E-UTRA), LTE Extra, LTE-A Pro, LTE LAA, MuLTEfire, and the like), Fifth Generation (5G) or New Radio (NR), narrowband IoT (NB-IOT), 3GPP Proximity Services (ProSe), and/or the like); ETSI RATs (e.g., High Performance Radio Metropolitan Area Network (HiperMAN), Intelligent Transport Systems (ITS) (e.g., ITS-G5, ITS-G5B, ITS-G5C, and the like), and the like); Institute of Electrical and Electronics Engineers (IEEE) technologies and/or WiFi (e.g., IEEE Standard for Local and Metropolitan Area Networks: Overview and Architecture, IEEE Std 802-2014, pp. 1-74 (30 Jun. 2014) (“[IEEE802]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), IEEE 802.15 technologies (e.g., IEEE Standard for Low-Rate Wireless Networks, IEEE Std 802.15.4-2020, pp. 1-800 (23 Jul. 2020) (“[IEEE802154]”) and variants thereof (e.g., ZigBee, WirelessHART, MiWi, ISA100.11a, Thread, IPv6 over Low power WPAN (6LoWPAN), and the like), IEEE Standard for Local and metropolitan area networks—Part 15.6: Wireless Body Area Networks, IEEE Std 802.15.6-2012, pp. 1-271 (29 Feb. 2012), and the like), WLAN V2X RATs (e.g., IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”) (which is now part of [IEEE80211]), IEEE Guide for Wireless Access in Vehicular Environments (WAVE) Architecture, IEEE STANDARDS ASSOCIATION, IEEE 1609.0-2019 (10 Apr. 2019) (“[IEEE16090]”), IEEE 802.11bd, Dedicated Short Range Communications (DSRC), and/or the like), Worldwide Interoperability for Microwave Access (WiMAX) (e.g., IEEE Standard for Air Interface for Broadband Wireless Access Systems, IEEE Std 802.16-2017, pp. 1-2726 (2 Mar. 2018) (“[WiMAX]”)), Mobile Broadband Wireless Access (MBWA)/iBurst (e.g., IEEE 802.20 and variants thereof), Wireless Gigabit Alliance (WiGig) standards (e.g., IEEE 802.11ad, IEEE 802.11ay, and the like), and so forth); Integrated Digital Enhanced Network (iDEN) and variants thereof (e.g., Wideband Integrated Digital Enhanced Network (WiDEN)); millimeter wave (mmWave) technologies/standards (e.g., wireless systems operating at 10-300 GHz and above 3GPP 5G); short-range and/or wireless personal area network (WPAN) technologies/standards (e.g., IEEE 802.15 technologies (e.g., as mentioned previously); Bluetooth and variants thereof (e.g., Bluetooth 5.3, Bluetooth Low Energy (BLE), and the like), WiFi-direct, Miracast, ANT/ANT+, Z-Wave, Universal Plug and Play (UPnP), low power Wide Area Networks (LPWANs), Long Range Wide Area Network (LoRA or LoRaWAN™), and the like); optical and/or visible light communication (VLC) technologies/standards (e.g., IEEE Standard for Local and metropolitan area networks—Part 15.7: Short-Range Optical Wireless Communications, IEEE Std 802.15.7-2018, pp. 1-407 (23 Apr. 2019), and the like); Sigfox; Mobitex; 3GPP2 technologies (e.g., cdmaOne (2G), Code Division Multiple Access 2000 (CDMA 2000), and Evolution-Data Optimized or Evolution-Data Only (EV-DO); Push-to-talk (PTT), Mobile Telephone System (MTS) and variants thereof (e.g., Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) and variants thereof (e.g., DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “carrier” at least in some examples refers to a modulated waveform conveying one or more physical channels (e.g., 5G/NR, E-UTRA, UTRA, and/or GSM/EDGE physical channels). The term “carrier frequency” at least in some examples refers to the center frequency of a cell.

The term “bearer” at least in some examples refers to an information transmission path of defined capacity, delay, bit error rate, and/or the like. The term “radio bearer” at least in some examples refers to the service provided by Layer 2 (L2) for transfer of user data between user equipment (UE) and a radio access network (RAN). The term “radio access bearer” at least in some examples refers to the service that the access stratum provides to the non-access stratum for transfer of user data between a UE and a CN.

The terms “beamforming” and “beam steering” at least in some examples refer to a spatial filtering mechanism used at a transmitter (Tx) to improve the received signal power, signal-to-noise ratio (SNR), or some other signalling metric at an intended receiver (Rx). The term “beamformer” at least in some examples refers to a STA that transmits a physical layer PDU (PPDU) using a beamforming steering matrix. The term “beamforming steering matrix” at least in some examples refers to a matrix determined using knowledge of the channel between a Tx and an intended Rx that maps from space-time streams to transmit antennas with the goal of improving the signal power, SNR, and/or some other signalling metric at the intended Rx.

The term “subframe” at least in some examples at least in some examples refers to a time interval during which a signal is signaled. In some implementations, a subframe is equal to 1 millisecond (ms). The term “time slot” at least in some examples at least in some examples refers to an integer multiple of consecutive subframes. The term “superframe” at least in some examples at least in some examples refers to a time interval comprising two time slots.

The term “channel coding” at least in some examples refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”. The term “network coding” at least in some examples refers to processes and/or techniques in which transmitted data is encoded and decoded to improve network performance. The term “code rate” at least in some examples refers to the proportion of a data stream or flow that is useful or non-redundant (e.g., for a code rate of k/n, for every k bits of useful information, the (en) coder generates a total of n bits of data, of which n−k are redundant). The term “systematic code” at least in some examples refers to any error correction code in which the input data is embedded in the encoded output. The term “non-systematic code” at least in some examples refers to any error correction code in which the input data is not embedded in the encoded output. The term “interleaving” at least in some examples refers to a process to rearrange code symbols so as to spread bursts of errors over multiple codewords that can be corrected by ECCs. The term “code word” or “codeword” at least in some examples refers to an element of a code or protocol, which is assembled in accordance with specific rules of the code or protocol.

The term “network address” at least in some examples refers to an identifier for a node or host in a computer network, and may be a unique identifier across a network and/or may be unique to a locally administered portion of the network. Examples of identifiers and/or network addresses can include am application identifier, Bluetooth hardware device address (BD_ADDR), a cellular network address (e.g., Absolute Radio-Frequency Channel Number (ARFCN), Access Point Name (APN), AMF name and/or AMF identifier (ID), AF-Service-Identifier, Cell Global Identifier (CGI) (e.g., NR CGI (NCGI), CGI NG-RAN, CGI EUTRA, and/or the like), Closed Access Group Identifier (CAG-ID), Edge Application Server (EAS) ID, Data Network Access Identifier (DNAI), Data Network Name (DNN), Evolved Cell Global Identifier (ECGI), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, gNB Identifier (gNB ID), Global gNB ID, International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Local NG-RAN Node Identifier, Mobile Subscriber Identification Number (MSIN), Mobile Subscriber/Station ISDN Number (MSISDN), Network identifier (NID), Network Slice Instance (NSI) ID, Network Slice AS Group (NSAG), Permanent Equipment Identifier (PEI), Public Land Mobile Network (PLMN) identity (ID), Physical Cell Identifier (PCI), QOS Flow ID (QFI) and/or 5G QoS Identifier (5Q1), RAN ID, Routing Indicator, Radio Network Temporary Identifier (RNTI) and variants thereof (e.g., any of those discussed in clause 8 of 3GPP TS 38.300 v17.4.0 (2023 Mar. 28) (“[TS38300]”)), SMS Function (SMSF) ID, Stand-alone Non-Public Network (SNPN) ID, Single Network Slice Selection Assistance information (S-NSSAI), sidelink identities (e.g., Source Layer-2 ID, Destination Layer-2 ID, PC5 Link Identifier, and the like), Subscription Concealed Identifier (SUCI), Subscription Permanent Identifier (SUPI), Temporary Mobile Subscriber Identity (TMSI) and variants thereof, Tracking Area identity (TAI), UE Access Category and Identity, and/or other cellular network related identifiers), CAG-ID, drivers license number, Global Trade Item Number (GTIN) (e.g., Australian Product Number (APN), EPC, European Article Number (EAN), Universal Product Code (UPC), and the like), email address, Enterprise Application Server (EAS) ID, an endpoint address, an Electronic Product Code (EPC) as defined by the EPCglobal Tag Data Standard, Fully Qualified Domain Name (FQDN), flow ID and/or flow hash, hash value, index, internet protocol (IP) address in an IP network (e.g., IP version 4 (IPv4), IP version 6 (IPv6), and the like), an internet packet exchange (IPX) address, LAN ID, a MAC address, personal area network (PAN) ID, port number (e.g., TCP port number, UDP port number, and the like), price lookup code (PLC), product key, QUIC connection ID, RFID tag, sequence number, service set identifier (SSID) and variants thereof, screen name, serial number, stock keeping unit (SKU), socket address, social security number (SSN), telephone number (e.g., in a public switched telephone network (PTSN)), unique identifier (UID) (e.g., including globally UID, universally unique identifier (UUID) (e.g., as specified in ISO/IEC 11578:1996), and the like), a Universal Resource Locator (URL) and/or Universal Resource Identifier (URI), user name (e.g., ID for logging into a service provider platform, such as a social network and/or some other service), vehicle identification number (VIN), Virtual LAN (VLAN) ID, X.21 address, an X.25 address, Zigbee® ID, Zigbee® Device Network ID, and/or any other suitable network address and components thereof.

The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service. Additionally or alternatively, the term “port” at least in some examples refers to a particular interface of the specified equipment (apparatus) with an electromagnetic environment (e.g., any connection point on an equipment intended for connection of cables to or from that equipment is considered as a port).

The term “delay” at least in some examples refers to a time interval between two events. Additionally or alternatively, the term “delay” at least in some examples refers to a time interval between the propagation of a signal and its reception. The term “delay bound” at least in some examples refers to a predetermined or configured amount of acceptable delay. The term “per-packet delay bound” at least in some examples refers to a predetermined or configured amount of acceptable packet delay where packets that are not processed and/or transmitted within the delay bound are considered to be delivery failures and are discarded or dropped. The term “goodput” at least in some examples refers to a number of useful information bits delivered by the network to a certain destination per unit of time. The term “jitter” at least in some examples refers to a deviation from a predefined (“true”) periodicity of a presumably periodic signal in relation to a reference clock signal. The term “latency” at least in some examples refers to the amount of time it takes to transfer a first/initial data unit in a data burst from one point to another. Additionally or alternatively, the term “latency” at least in some examples refers to the delay experienced by a data unit (e.g., frame) in the course of its propagation between two points in a network, measured from the time that a known reference point in the frame passes the first point to the time that the reference point in the data unit passes the second point. The term “network delay” at least in some examples refers to the delay of an a data unit within a network (e.g., an IP packet within an IP network). The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized. The term “packet drop rate” at least in some examples refers to a share of packets that were not sent to the target due to high traffic load or traffic management and should be seen as a part of the packet loss rate. The term “packet loss rate” at least in some examples refers to a share of packets that could not be received by the target, including packets dropped, packets lost in transmission and packets received in wrong format. The term “performance indicator” at least in some examples refers to performance data aggregated over a group of network functions (NFs), which is derived from performance measurements collected at the NFs that belong to the group, according to the aggregation method identified in a Performance Indicator definition. The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver. The term “processing delay” at least in some examples refers to an amount of time taken to process a packet in a network node. The term “propagation delay” at least in some examples refers to amount of time it takes a signal's header to travel from a sender to a receiver. The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted. The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel. The term “transmission delay” at least in some examples refers to an amount of time needed (or necessary) to push a packet (or all bits of a packet) into a transmission medium.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data processing, automated reasoning tasks, and/or the like.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The terms “instantiate,” “instantiation,” and the like at least in some examples refers to the creation of an instance. An “instance” also at least in some examples refers to a concrete occurrence of an object, which may occur, for example, during execution of program code.

The term “reference point” at least in some examples refers to a conceptual point at the conjunction of two non-overlapping functional groups, elements, or entities.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some examples refers to an abstract representation of any entity issuing commands, requests, and/or data to a compute node or system, and/or otherwise consumes or uses services. Additionally or alternatively, the term “user” at least in some examples refers to an entity, not part of the 3GPP System, which uses 3GPP System services (e.g., a person using a 3GPP system mobile station as a portable telephone). The term “user profile” at least in some examples refers to a set of information to provide a user with a consistent, personalised service environment, irrespective of the user's location or the terminal used (within the limitations of the terminal and the serving network).

The terms “configuration”, “policy”, “ruleset”, and/or “operational parameters”, at least in some examples refer to a machine-readable information object that contains instructions, conditions, parameters, and/or criteria that are relevant to a device, system, or other element/entity.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a IEEE 802 protocol/standard (e.g., [IEEE80211] or the like), Type Length Value (TLV), and/or other like data structures. The term “packet” at least in some examples refers to an information unit identified by a label at layer 3 of the OSI reference model. In some examples, a “packet” may also be referred to as a “network protocol data unit” or “NPDU”. The term “protocol data unit” at least in some examples refers to a unit of data specified in an (N)-protocol layer and includes (N)-protocol control information and possibly (N)-user data.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element, or a data element that contains content. The term “data frame”, “data field”, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to a markup construct including a name-value pair that exists within a start tag or empty element tag. Attributes contain data related to its element and/or control the element's behavior. The term “type length value”, “tag length value”, or “TLV” at least in some examples refers to an encoding scheme used for informational elements in a protocol; TLVs are sometimes used to encode additional or optional information elements in a protocol. In some examples, a TLV-encoded data stream contains code related to the type of value, the length of the value, and the value itself. In some examples, the type in a TLV includes a binary and/or alphanumeric code, which indicates the kind of field that this part of the message represents; the length in a TL V includes a size of the value field (e.g., in bytes); and the value in a TLV includes a variable-sized series of bytes which contains data for this part of the message.

The term “reference” at least in some examples refers to data useable to locate other data and may be implemented a variety of ways (e.g., a pointer, an index, a handle, a key, an identifier, a hyperlink, and/or the like).

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “Nyquist criterion” or “Nyquist frequency” at least in some examples refers to a characteristic of a sampler, which converts a continuous function or signal into a discrete sequence. Additionally or alternatively, the term “Nyquist criterion” or “Nyquist frequency” at least in some examples refers to a frequency (e.g., cycles per second), for a given sampling rate (e.g., samples per second), whose cycle-length (or period) is twice the interval between samples.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably. The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model” represents a data-generating process.

The term “machine learning algorithm” or “ML algorithm” at least in some examples refers to an application, program, process, algorithm, and/or function that builds or estimates an ML model based on sample data or training data. Additionally or alternatively, the term “machine learning algorithm” or “ML algorithm” at least in some examples refers to a program, process, algorithm, and/or function that learns from experience w.r.t some task(s) and some performance measure(s)/metric(s), and an ML model is an object or data structure created after an ML algorithm is trained with training data. For purposes of the present disclosure, the terms “ML algorithm”, “AI algorithm”, “AI/ML algorithm”, and the like may be used interchangeably. Additionally, although the term “ML algorithm” may refer to different concepts than the term “ML model,” these terms may be used interchangeably for the purposes of the present disclosure.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result.

The term “probability” at least in some examples refers to a numerical description of how likely an event is to occur and/or how likely it is that a proposition is true. The term “probability distribution” at least in some examples refers to a mathematical function that gives the probabilities of occurrence of different possible outcomes for an experiment or event.

The term “predictive service” at least in some examples refers to a service model which provides reliable performance, but allowing a specified variance in the measured performance criteria.

The term “Timing Advance Group” or “TAG” at least in some examples refers to a group of serving cells that is configured by RRC and that, for the cells with a UL configured, using the same timing reference cell and the same Timing Advance (TA) value. In some examples, a TAG containing the SpCell of a MAC entity is referred to as a Primary TAG (PTAG), and the term Secondary TAG (STAG) refers to other TAGs.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1.-34. (canceled)

35. An electronic device comprising:
one or more processors configured to implement a medium access control (MAC) entity for single or multiple Transmission Reception Point (TRP) operation; and
one or more non-transitory computer-readable media comprising instructions that, upon execution of the instructions, are to cause the MAC entity to:
identify a received timing advance command (TAC) that includes a timing advance (TA) value;
determine a TRP identity (TRP-Id) associated with the TA value, wherein the TRP-Id is assigned to a TRP among a set of TRPs belonging to the serving cell;
determine an uplink (UL) transmission to which the TA value is to be applied;
adjust a UL timing for the determined UL transmission using the TA value; and
transmit the UL transmission according to the adjusted UL timing.

36. The electronic device of claim 35, wherein the serving cell is associated with at least two TAs.

37. The electronic device of claim 35, wherein the serving cell is associated with at least two TACs.

38. The electronic device of claim 35, wherein the instructions are further to cause the MAC entity to identify a received radio resource control (RRC) configuration that includes an indication of a TA group (TAG) identity to which the serving cell belongs.

39. The electronic device of claim 35, wherein the instructions are further to cause the MAC entity to determine a TAG identifier (TAG-Id) of a TAG to which the serving cell belongs based on an SRS resource indicator field in received downlink control information (DCI).

40. The electronic device of claim 35, wherein the instructions are further to cause the MAC entity to determine a TAG-Id of a TAG to which the serving cell belongs based on a PUCCH resource indicator field in received DCI.

41. The electronic device of claim 35, wherein the TRP-Id is associated with a transmission configuration indicator (TCI) state are associated with a TRP-Id, and a TRP-Id is associated with a TA

42. The electronic device of claim 35, wherein the TAC is included in a TAC medium access control (MAC) control element (CE), an absolute TAC MAC CE, or a random access response (RAR) message.

43. The electronic device of claim 35, wherein the UL transmission is a PUSCH transmission, a PUCCH transmission, or a SRS transmission.

44. The electronic device of claim 35, wherein the instructions are further to cause the MAC entity to:
perform measurements on a set of received channel state information reference signals (CSI-RSs) within a time window; and
determine predicted Doppler-domain compressed channel state information (CSI) associated with a reference resource after reporting the CSI to a radio access network (RAN) node.

45. The electronic device of claim 35, wherein the instructions are further to cause the MAC entity to:
perform measurements on a set of received CSI-RSs within a time window; and
determine predicted Doppler-domain compressed channel state information (CSI) associated with a reference resource before reporting the CSI to a RAN node.

46. The electronic device of claim 35, wherein the instructions are further to cause the MAC entity to perform the measurements on each CSI-RS of the set of received CSI-RSs during respective CSI-RS sampling periods within the time window,

47. The electronic device of claim 35, wherein the transmission of the UL transmission includes transmitting the UL transmission according to a codebook-based transmission scheme.

48. One or more non-transitory computer-readable media comprising instructions that, upon execution of the instructions by one or more processors of an electronic device, are to caause a medium access control (MAC) entity for single or multiple Transmission Reception Point (TRP) operation to:
identify a received timing advance command (TAC) that includes a timing advance (TA) value;
determine a TRP identity (TRP-Id) associated with the TA value, wherein the TRP-Id is assigned to a TRP among a set of TRPs belonging to the serving cell;
determine an uplink (UL) transmission to which the TA value is to be applied;
adjust a UL timing for the determined UL transmission using the TA value; and
transmit the UL transmission according to the adjusted UL timing.

49. The one or more non-transitory computer-readable media of claim 48, wherein the serving cell is associated with at least two TAs.

50. The one or more non-transitory computer-readable media of claim 48, wherein the serving cell is associated with at least two TACs.

51. The one or more non-transitory computer-readable media of claim 48, wherein the instructions are further to cause the MAC entity to identify a received radio resource control (RRC) configuration that includes an indication of a TA group (TAG) identity to which the serving cell belongs.

52. The one or more non-transitory computer-readable media of claim 48, wherein the instructions are further to cause the MAC entity to determine a TAG identifier (TAG-Id) of a TAG to which the serving cell belongs based on an SRS resource indicator field in received downlink control information (DCI).

53. The one or more non-transitory computer-readable media of claim 48, wherein the instructions are further to cause the MAC entity to determine a TAG-Id of a TAG to which the serving cell belongs based on a PUCCH resource indicator field in received DCI.

54. The one or more non-transitory computer-readable media of claim 48, wherein the TRP-Id is associated with a transmission configuration indicator (TCI) state are associated with a TRP-Id, and a TRP-Id is associated with a TA.
